(19) United States
(12) Patent Application Publication
(10) Pub. No.: US 2020/0050388 A1
(43) Pub. Date: Feb. 13, 2020

(54) INFORMATION SYSTEM

(71) Applicant: HITACHI, LTD., Tokyo (JP)

(72) Inventors: Masanori TAKATA, Tokyo (JP); Hideo SAITO, Tokyo (JP); Masakuni AGETSUMA, Tokyo (JP); Takahiro YAMAMOTO, Tokyo (JP); Akira YAMAMOTO, Tokyo (JP)

(21) Appl. No.: 16/297,953

(22) Filed: Mar. 11, 2019

(30) Foreign Application Priority Data
Aug. 10, 2018 (JP) 2018-151868

(51) Int. Cl. G06F 3/06; H04L 29/08

(52) U.S. Cl. CPC G06F 3/0647; G06F 3/067; G06F 3/0607; H04L 67/1097

(57) ABSTRACT

In an information system including a plurality of computers each of which includes a processor and a storage device, where the information system inputs/outputs data to/from the storage device based on a request from a client program, when migrating data stored in a migration source information system to a storage device of a self information system, the processor transmits an instruction to cause a client program exerted on the migration source information system as the data migration source to generate an access means to access the data to be migrated of the migration source information system, and stores the data to be migrated in the storage device of the information system using the access means generated by the client program of the migration source information system.

### BACKGROUND OF THE INVENTION

### 1. Field of the Invention

The present invention is generally relates to an information system, for example, an Information system including a computer that operates as at least part of software defined storage (SDS).

### 2. Description of the Related Art

A storage system virtualization technology has been offered as a technique for reducing the management cost of the storage system (one or more storage apparatuses). In this technology, management cost is reduced, and usability of the storage system is improved by implementing unified management of a wide variety of storage systems with different management methods using virtualization technology.

JP 10-283272 A relates to a virtualization technique of a storage system. JP 10-283272 A discloses a computer system in which a second storage system is connected to a first storage system connected to a host computer. In this computer system, the volume of the second storage system is provided as the volume of the first storage system for the host computer. In this configuration, the second storage system is concealed from the host computer, and all read/write requests of the host computer are issued to the first storage system. If the read/write request received from the host computer is for the volume of the second storage system, the first storage system issues the request to the second storage system, and the read/write request is performed. In this way, the administrator of the storage substantially manages only the first storage system, so that it is possible to drastically reduce the management man-hour of the storage system.

On the other hand, the SDS (Software Defined Storage) attracts attention in recent years. The Software for SDS having a storage function (referred to as “storage control program” in this specification) is executed by a physical computer (for example, a general-purpose computer), so that the computer can be a storage apparatus (that is, the computer becomes an SDS apparatus). When a vendor provides a storage apparatus as an SDS apparatus, the vendor provide a storage control program to a user. The user installs the storage control program in the computer prepared by the user. As a result, the computer becomes the SDS apparatus.

### SUMMARY OF THE INVENTION

Data migration may be necessary between SDS systems. However, depending on the migration source SDS, there may be a client program exerted on the migration source SDS for data input/output, so that it may be impossible to migrate data between SDS systems.

Such a problem may occur to a data migration between information systems other than SDS.

In an information system including a plurality of computers each of which includes a processor and a storage device, where the information system inputs/outputs data to/from the storage device based on a request from a client program, when migrating data stored in a migration source information system to a storage device of a self information system, the processor transmits an instruction to cause a client program exerted on the migration source information system as the data migration source to generate an access means to access the data to be migrated of the migration source information system, and stores the data to be migrated in the storage device of the information system using the access means generated by the client program of the migration source information system.

According to the present invention, even if there is a client program exerted on the source SDS for inputting and outputting data, it is possible to migrate data between information systems.

### BRIEF DESCRIPTION OF THE DRAWINGS

FIG. 1 is a diagram showing a configuration of an information system in an embodiment;

FIG. 2 is a diagram showing a configuration of an SDS system in an embodiment;

FIG. 3 is a diagram for explaining an outline of a flow of data migration between SDS systems having different access protocols;

FIG. 4 is a diagram showing an example of a format of an I/O request in this embodiment;

FIG. 5 is a diagram for explaining the concept of a Thin Provisioning function in the present embodiment;

FIG. 6 is a diagram showing information included in management information;

FIG. 7 is a diagram showing a format of logical volume information;

FIG. 8 is a diagram showing a format of real page information;

FIG. 9 is a diagram showing a format of storage unit information;

FIG. 10 is a diagram showing a format of storage unit group information;

FIG. 11 is a diagram showing the structure of a free page management information queue;

FIG. 12 is a diagram showing program modules included in a storage control program;

FIG. 13 is a diagram showing a flow of an SDS migration process;

FIG. 14 is a diagram showing part of a processing flow of a read processing execution unit;

FIG. 15 is a diagram showing the rest of a processing flow of the read processing execution unit;

FIG. 16 is a diagram showing part of a processing flow of a write processing execution unit;

FIG. 17 is a diagram showing the rest of the processing flow of the write processing execution unit;

FIG. 18 is a diagram showing a processing flow of a copy processing scheduling unit; and

FIG. 19 is a diagram showing a processing flow of a copy processing execution unit.

### DESCRIPTION OF THE PREFERRED EMBODIMENTS

Hereinafter, embodiments of the present invention will be described with reference to the drawings. It is to be noted that the embodiment described below does not limit the invention according to the claims. In addition, all of the elements and combinations thereof described in the embodiments are not necessarily indispensable for solving means of the invention.

Before describing the embodiments, various terms used in the examples will be described.

In the embodiment described below, unless otherwise noted, a physical storage apparatus (that is, a storage apparatus configured with dedicated hardware) is referred to as a “conventional storage apparatus”. In addition, in the embodiment described below, a physical computer (for example, a general-purpose computer) in which the storage control program is installed is referred to as “SDS”.

In the embodiment described below, the term “storage apparatus” is used as a word meaning both conventional storage apparatus and SDS. For example, when describing the functions and features shared by the conventional storage apparatus and SDS in common, the term “storage apparatus” is used.

The term “volume” means a storage space provided by a target device such as a storage apparatus or a storage device to an initiator of a host computer or the like. When the initiator issues an I/O (input/output) request, for example a read request, to the area on the volume, the target device providing the volume reads the data from the area on the target device associated with the area, and return it to the initiator.

Some of the storage apparatus may, as a volume, provide a virtual volume formed by so-called Thin Provisioning technology to the initiator. In the embodiment described below, the function of providing a virtual volume to an initiator is referred to as “Thin Provisioning function”.

In the initial state (immediately after being defined) of the virtual volume, the storage device is not associated with the area on the storage space. When the initiator issues a data write request to the area on the storage space, the storage apparatus can dynamically determine a storage device associated with the area. The SDS in the embodiment described below can provide a virtual volume to the initiator.

“Volume virtualization function” (or simply referred to as “virtualization function”) is a function to provide a volume possessed by other storage apparatuses to the initiator device as the own volume. The virtualization function of the volume is implemented by, for example, a dedicated device (for example, called a virtualization appliance). Alternatively, the storage apparatus may have a volume virtualization function.

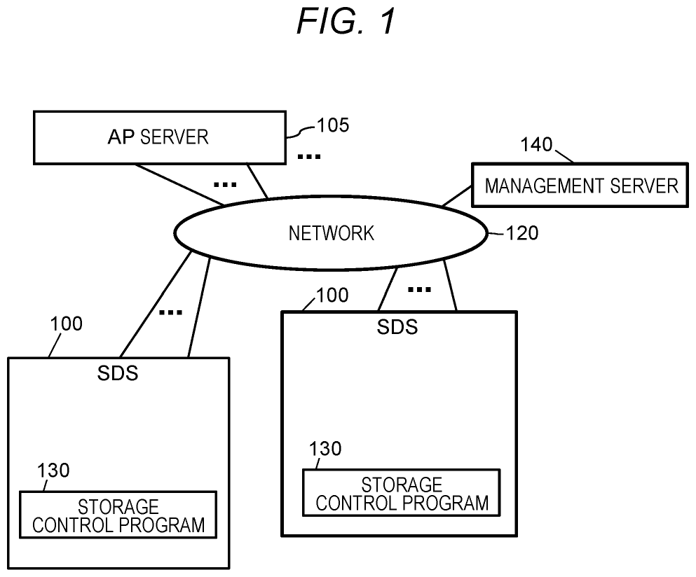

FIG. 1 shows a configuration of an information system in this embodiment.

The information system has a plurality of server computers (100, 105, and 140), and these server computers (100, 105, and 140) are mutually connected by a network 120. The server computers (100, 105, and 140) may be a general-purpose computer such as a personal computer, and may have the same basic hardware configurations. However, the hardware configurations of the server computers (100, 105, and 140) may not completely identical. For example, the number of processors (for example, CPU (Central Processing Unit)), the memory capacity, and the like of the server computers (100, 105, and 140) may be different.

Among the plurality of server computers (100, 105, and 140) the server computer 105 is a computer on which an application program (AP) used by a user is executed, and is hereinafter referred to as an “AP server 105”. The application program may be, for example, a database management system (DBMS) or a program such as spreadsheet software or word processor. The AP server 105 is an example of a host system.

On the other hand, the server computer 100 is a computer that operates as a storage apparatus that stores data used by the AP server 105. The server computer 100 operates as a storage apparatus by executing a storage control program 130 by the processor of the server computer 100. For this reason, hereinafter, the server computer 100 is referred to as “SDS 100”.

The SDS 100 can define one or more volumes, and the defined volume is provided to an initiator such as the AP server 105. The AP server 105 issues a write request to (SDS 100 that is providing) the volume, so that the AP server 105 stores data (for example, a database table or the like) generated by an application program in a volume, and read the data from the volume by issuing a read request to (SDS 100 that is providing) the volume.

The server computer 140 is a computer used by a user or an administrator (hereinafter simply referred to as a “user”) of the information system to perform the management operation of the information system, and hereinafter is referred to as a “management server 140”. The management server 140 has an input device such as a keyboard and a mouse, and an output device such as a display, which are used when the user performs the management operation of the information system. Naturally, the server computer (SDS 100, AP server 105) other than the management server 140 may also have an input device and an output device.

At least one of the SDS 100, the AP server 105, and the management server 140 may be a virtual device provided based on a computer resource pool (for example, an interface device, a memory, and a processor) such as a cloud infrastructure. A plurality of the SDS systems 100, the AP servers 105, and the management servers 140 may exist in the information system. However, in this embodiment, an example where one AP server 105 and one management server 140 exist in the information system, and two or more SDS systems 100 exist in the information system will be described. Further, in this embodiment, data migration is performed between the SDS systems 100 where the storage control programs 130 executed by the migration source SDS 100 and the migration destination SDS 100 are different, so that the access protocols of the source SDS 100 and the destination SDS 100 (typically, protocol for transmitting an I/O request and receiving its response) are different.

As the network 120, for example, a transmission medium such as the Ethernet (registered trademark) or a fiber channel is used. When the AP server 105 reads and writes data from/to the SDS 100, the network 120 is used, and in addition, is used when the management operation commands (or various management information) between the management server 140 and the SDS 100 (or the AP server 105) are exchanged. As another example, however, two types of networks, which are a network for transmitting and receiving data read/written between the AP server 105 and the SDS 100, and a network for the management server 140 to transmit and receive management operation commands and the like may be provided. That is, the network 120 may be a single network, or a plurality of networks.

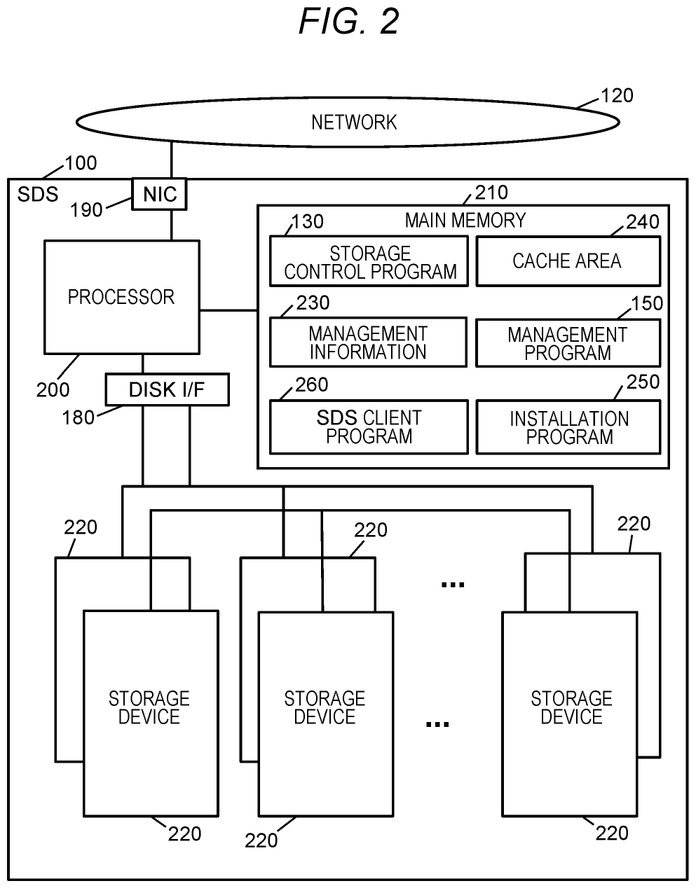

FIG. 2 shows the configuration of the SDS 100.

The SDS 100 includes a main memory (memory) 210, a storage device 220, a network interface controller (NIC) 190, a disk interface (DISK I/F) 180, and a processor (CPU) 200 connected thereto. At least one component of the processor 200, the memory, the storage device 220, the NIC 190 and the DISK I/F 180 may be one or more.

The processor 200 executes each program loaded in the main memory 210. The main memory 210 is a volatile memory such as a DRAM (Dynamic Random Access Memory), and the main memory 210 stores the storage control program 130, a management program 150, an install program 250, and management information 230 used by the storage control program 130.

On the other hand, the storage device 220 is a storage device having a nonvolatile storage medium such as a magnetic disk or a flash memory, and is used that stores data written from the AP server 105. Note that the storage control program 130, the management information 230, and the like described above are stored in the storage device 220 when the SDS 100 is not in operation (when the power is OFF), and may be loaded from the storage device 220 into the main memory 210 when the SDS 100 is activated.

The DISK I/F 180 is an interface device provided between the processor 200 and the storage device 220. On the other hand, the NIC 190 is an interface device for connecting the SDS 100 to the network 120, and also has a port for connecting a transmission line (network cable) provided between the SDS 100 and the network 120. Therefore, in the following, the NIC 190 may be referred to as a “port 190” in some cases. Communication via the port 190 may be wireless communication instead of communication via the transmission line.

Next, the roles of the programs stored in the main memory 210 will be outlined. In the following description, with respect to processing executed by the server computer (SDS 100, AP server 105, management server 140, etc.), although there are cases where explanation is made with a “program” as the subject, actually, processing described in the program is performed by the processor of the server computer executing the program. However, in order to prevent the explanation from becoming redundant, the contents of processing with the program as the subject may be described. And the subject of the processing described with the program as the subject is actually the processor which executes the program.

The storage control program 130 is a program for causing the SDS 100 (that is, the server computer) to function as a storage apparatus. Specifically, for example, by the function of the storage control program 130, the SDS 100 provides one or more volumes to an initiator such as the AP server 105, accepts an I/O request (read request or write request) from the initiator to return the data at the address designated by the read request to the initiator, and performs processing such as storing the write data designated by the write request in the volume, or the like. The conventional storage apparatus has functions other than providing a volume (for example, creating a mirror copy of the volume, etc.). Similarly, the storage control program 130 may be a program that implements functions other than providing a volume in the SDS 100.

Also, the storage control program 130 reserves an area 240 on the main memory 210 for holding data frequently accessed from the AP server 105. The area 240 for holding data frequently accessed from the AP server 105 is referred to as a “cache area 240”. However, the SDS 100 may not necessarily have the cache area 240.

Further, the SDS 100 may have a means for preventing the data stored in the main memory 210 from being lost at the time of failure such as power outage. For example, the SDS 100 may have a battery, and may maintain the data on main memory 210 using the electric power supplied from the battery at the time of power outage. However, the SDS 100 may not necessarily have data maintenance means such as a battery.

The management program 150 is a program for managing the storage apparatus (SDS) in the information system. Specifically, for example, the management performed in the management program 150 means operations such as definition and deletion of volumes, monitoring of the state of the SDS 100, and the like. In the present embodiment, an example in which the management program 150 is installed in a specific one SDS 100 (SDS #x to be described later) in the information system will be described. The management program 150 can manage all the SDS systems in the information system. Also, in the management server 140, a communication program (not shown) for communicating with the management program 150 executed in the SDS 100 is executed, and the user instructs the management server 140 to define the volume and the like by using the communication program.

The install program 250 is a program for installing the program. The install program 250 is possessed by each SDS 100 in the information system. For example, the storage control program 130 is installed in the SDS 100 by the install program 250. For example, when the user installs a program, the user uses the management server 140 to issue an installation instruction to the management program 150 to be executed by the SDS 100. The management program 150 that has received the installation instruction causes the install program 250 of the SDS 100 of the install destination of the program to install the program. Installation of the program may be performed without the user's instruction. For example, at least programs other than the install program 250 may be installed from a program source into a device such as a computer. The program source may be, for example, a program distribution server or a (for example, non-transitory) recording medium readable by a computer. In addition, in the following description, two or more programs may be implemented as one program, or one program may be implemented as two or more programs.

The install program 250 can also install an SDS client program 260. The SDS client program 260 will be described later.

In the SDS 100, programs other than the above-described program may also be executed. For example, in (the processor 200 of) the SDS 100, an operating system executed by a general-purpose computer may be executed, and in this case, the storage control program 130 or the like may operate while using the functions provided by the operating system. Alternatively, a program (for example, referred to as a hypervisor) for defining a so-called virtual computer on the SDS 100 may be executed, and in this case, the storage control program 130 or the like may be executed on the defined virtual computer.

In the information system according to the present embodiment, a plurality of SDS systems 100 coexists. In the present embodiment, the storage control programs 130 executed by at least two SDS systems 100 are storage control programs 130 having different specifications (at least access protocols). It can be said that the storage control programs 130 having different specifications (at least access protocols) are the storage control programs 130 having different types. When plural types of storage control programs 130 are executed in the information system, although each of the storage control programs 130 must be at least a program that can be executed by a general-purpose computer (such as a server computer in this embodiment), and a program capable of causing the SDS 100 to provide a minimum function as a storage apparatus, it may have supported functions that are different. It is to be noted that the minimum function as a storage apparatus may be a function to perform the I/O of data according to the I/O request.

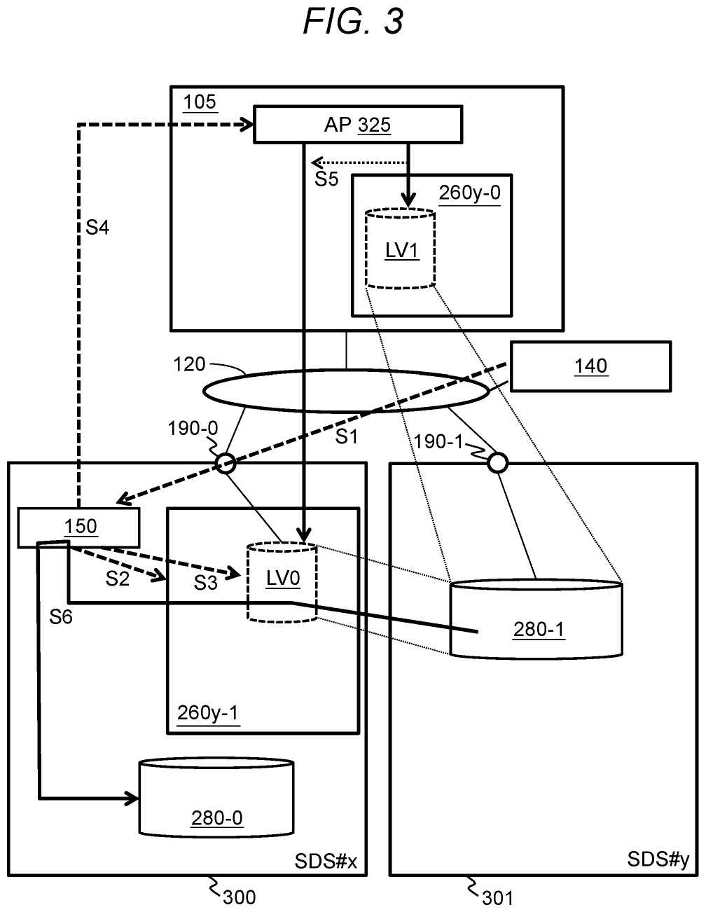

In the present embodiment, with the mechanism illustrated in FIG. 3, data migration between SDS systems with different access protocols is possible.

FIG. 3 is a diagram for explaining an outline of a flow of data migration between SDS systems having different access protocols.

As shown in FIG. 3, there is a migration destination SDS system 100 (hereinafter referred to as “SDS #x(300)”). Also, there is a migration source SDS system 100 (hereinafter referred to as “SDS #y(301)”) that communicates with an access protocol different from the access protocol of the SDS #x.

Although the number of the SDS systems #x(300) and the SDS systems #y(301) existing in the information system may be either one or more, in the present embodiment, unless otherwise specified, an example will be described in which there is one SDS #x(300) and one SDS #y(301) in the information system.

The access protocol of the SDS #x(300) is a general-purpose access protocol like the SCSI protocol. The term “Generic access protocol” is an example of the second access protocol, and is an access protocol used for communication without (without through) an SDS client program of the SDS #x(300). For example, an I/O request (command) exchanged between the SDS #x(300) and the AP server 105 is a command conforming to the SCSI standard (hereinafter referred to as “SCSI command”) standardized by ANSI T10.

On the other hand, the access protocol of the SDS #y(301) is a vendor-specified access protocol (hereinafter vendor protocol) of the SDS #y(301). The terra “Vendor protocol” is an example of the first access protocol, and is an access protocol used for communication with the SDS client program 260 for SDS #y out of one or more SDS client programs 260. The SDS client; program 260 is a program that provides a volume and that transmits an I/O request that has designated an address corresponding to the I/O destination of the I/O and belonging to the storage space associated with the volume when the I/O to the volume is accepted. Hereinafter, the SDS client program 260 for SDS #y is referred to as an “SDS client program 260y”, and the reference number in the notation shall be given a branch number in accordance with the installation destination of the SDS client program 260y.

In (the processor of) the AP server 105, an AP (application program) 325 is executed. In order for the data to which I/O is to be performed of the AP 325 to be stored in the SDS #y(301) the SDS client program 260y is necessary for communication with SDS #y(301). For this reason, the SDS client program 260y is installed into the AP server 105. The SDS client program 260y installed in the AP server 105 is referred to as an “SDS client program 260y-0”.

The SDS client program 260y-0 generates a volume LV1 (an example of a first volume) associated with a storage space 280-1 (an example of the first storage space) provided by the SDS #y(301), and manages the volume LV1. The volume LV1 is generated in accordance with an instruction from the AP 325, for example. The AP 325 is an example of an external program (a program external to the SDS client program 260y-0) in a device (for example, a physical or virtual device) having the SDS client program 260y-0. In the logical hierarchy of the device, the AP 325 may be a program located in a layer higher than the layer of the SDS client program 260y-0. At least part of the address range of the storage space 280-1 may be associated with the address range of the generated volume LV1. The storage space 280-1 may be provided to the SDS client program 260y-0 via a port 190-1 of the SDS #y(301).

The volume LV1 is provided to the AP 325 by the SDS client program 260y-0. The AP 325 performs an I/O to the volume LV1. When the SDS client program 260y-0 accepts the I/O to the volume LV1, the SDS client program 260y-0 converts an I/O destination (for example, an address) of the I/O to an address (an address belonging to the storage space 280-1) corresponding to the I/O destination, and transmits the I/O request designating the converted address to the SDS #y(301) in accordance with the vendor protocol. In response to the I/O request, the SDS #y(301) stores data to which the I/O is to be performed in accordance with the I/O request in the storage space 280-1. The storage space 280-1 is a storage space based on one or more storage devices 220 (for example, a storage device group such as a RAID group) in the SDS #y(301). A first address map showing the relationship between the address belonging to volume LV1 and the address belonging to the storage space 280-1 is managed in at least one of the SDS client program 260y-0 and the SDS #y(301). The first address map is periodically or irregularly transmitted from at least one of the SDS client program 260y-0 and the SDS #y(301) to the management server 140. For example, the management server 140 manages the first address map, and the first address map in the management server 140 is synchronized with the first address map in at least one of the SDS client program 260y-0 and SDS #y(301). It should be noted that the first address map may indicate the correspondence with the entire area of the volume LV1, or may indicate the correspondence with the address of the data write destination in the volume LV1.

The management server 140 manages the SDS #y(301) and the SDS #x(300). The management server 140 may manage the AP server 105 in addition to the SDS #y(301) and the SDS #x(300). For example, the management server 140, for each AP server 105, may hold information indicating at least one of the following:

The address (for example, IP address) of the AP server 105

The ID of the SDS client program 260 installed in the AP server 105

The ID of the volume managed by the SDS client program 260

The ID of the AP 325 that performs an I/O to the volume managed by the SDS client program 260

The address map for a volume (information indicating a correspondence between an address belonging to the volume and an address belonging to the storage space associated with the volume). Further, for example, the management server 140 may manage at least part of the management information 230 (see FIG. 2) possessed by each SDS to be managed. For each SDS, the management server 140, for example, may manage the address of the SDS, and the ID of the storage space possessed by the SDS.

In the case where the storage space 280-1 is associated with the volume LV1, the management server 140 transmits the migration instruction to the management program 150 in the SDS #x(300) (S1). The migration instruction may be transmitted in response to an instruction from the user to the management server 140 via the input device or the AP server 105, or may be transmitted in response to the detection of the addition of the SDS #x(300) to the information system (for example, the addition to network 120). In addition, the following parameters are associated with the migration instruction (some parameters may be omitted).

The address of the SDS #y(301) (an example of the migration source SDS)

The first address map (information indicating the correspondence between the address belonging to the volume LV1 and the address belonging to the storage space 280-1) possessed by the management server 140

The ID of the storage space 280-1

Authentication information (for example, the ID and the password of the SDS client program 260 for SDS #y) necessary for accessing the storage space 280-1

The address of the AP server 105

The ID of the AP 325

The management program 150 in the SDS #x(300) performs S2 to S5 in response to the migration instruction. In the following description, an address belonging to the volume LV1 may be referred to as a “first volume address”, an address belonging to the storage space 280-1 may be referred to as a “first space address”, an address belonging to the volume LV0 may be referred to as a “second volume address”, and an address belonging to a storage space 280-0 (an example of the second storage space) possessed by the SDS #x(300) may be referred to as a “second space address”. Further, the first volume address and the second volume address can be collectively referred to as “volume address” and similarly, the first space address and the second space address can be collectively referred to as “space address”.

If the SDS client program 260y for SDS #v indicated by the program ID (ID of the SDS client program 260 for SDS #y) designated by the migration instruction is not installed, the management program 150 calls the install program 250. The install program 250 identifies the SDS client program 260y for SDS #y using the program ID as a key, and installs the identified SDS client program 260y from the program source (not shown) to the SDS #x(300) (S2) The SDS client program 260y for SDS #y installed in the SDS #x(300) is referred to as an “SDS client program 260y-1”. The program ID is associated with the migration instruction and the SDS client program 260y for SDS #y is installed in response to the migration instruction, so that a particular installation instruction can be made unnecessary.

The management program 150 Instructs the SDS client program 260y-1 to generate the volume LV0 (an example of a second volume) associated with the storage space 280-1 (S3). In this instruction, the first address map is associated. The first address map (and a second address map described later) may be, for example, file system information. In response to this instruction, the SDS client program 260y-1 generates the volume LV0 associated with the storage space 280-1, and manages the volume LV0. For each of two or more second volume addresses corresponding (for example, matched) to two or more respective first volume addresses indicated by the first address map among the plurality of second volume addresses belonging to the generated volume LV0, the first space address indicated by the first address map (the first space address mapped to the first volume address corresponding to the second volume address) among the plurality of first space addresses to which the storage space 280-1 belongs is mapped in the second volume address. The second address map indicating the correspondence between the second volume address and the second space address is managed in at least one of the SDS client program 260y-1 and the SDS #x(300).

The volume LV0 is a volume to which the I/O is performed from the AP 325 instead of the volume LV1. Specifically, for example, the management program 150 uses the server address (address of the AP server 105) designated by the migration instruction to transmit one or more instructions to the AP server 105 (S4). The one or more instructions is an instruction of recognizing the volume LV0, and an instruction of switching the path used for the I/O from the path connected to the volume LVI to a path connected to the volume LV0. In the one or more instructions, the ID of the AP 325, the ID of the volume LV0, and the ID of the SDS client program 260y-1 are designated. In response to the one or more instructions, the volume LV0 managed by the SDS client program 260y-1 is recognized for the AP 325 designated by the one or more instructions, and the path used for the I/O is switched from the path connected to the volume LVI to the path connected to the volume LV0 (S5). Thereafter, the AP 325 performs the I/O to the volume LV0 instead of the I/O to the volume LV1. Note that at least one of the instruction of recognizing the volume LV0, and the instruction of switching the path may be automatically transmitted from the management server 140 to the AP server 105, or may by input (for example, input via the input device of the AP server 105 or the management server 140) by the user to the AP server 105 instead of the management program 150.

Data copy is performed in which the management program 150 (or in response to an instruction from the management program 150, the SDS client program 260y-1) copies data to be migrated (data stored from the AP 325 via the volume LV1) from the storage space 280-1 to the storage space 280-0 via the volume LV0 (S6). The data copy may be completed by, for example, sequentially reading (read from a storage unit 280-1) and writing (written into a storage unit 280-0) data from the head address of the volume LV0. The data copy includes the following (m1) and (m2) with respect to each second volume address at which writing to the storage unit 280-0 has not been completed among the two or more second volume addresses identified from the second address map (the address map generated on the basis of the first address map).

(m1) The management program 150 (or the SDS client program 260y-1) performs reading designating the second volume address for the volume LV0 (transmit a read request to the SDS client program 260y-1 for reading data from the volume LV0). In the reading, a protocol different from the vendor protocol and standardized (for example, a general-purpose protocol such as SCSI protocol) is used. Next, when the SDS client program 260y-1 accepts reading for the second volume address, the SDS client program. 260y-1 converts the second volume address into the first space address based on the second address map (the address map generated based on the first address map), and transmits a read request designating the first space address to the SDS #y(301) in accordance with the vendor protocol. In response to the read request, data to be migrated is read from the storage unit 280-1 by SDS #y(301), and the SDS client program 260y-1 receives the read data to be migrated from the SDS #y(301). Then, the data to be migrated is returned from the SDS client program 260y-1 to the management program 150. In returning the data to be migrated from the SDS client program 260y-1 to the management program 150, the standardized protocol is used. That is, there is no need to use the vendor protocol in communication between the management program 150 and the SDS client program 260y-1.

(m2) The management program 150 (or the SDS client program 260y-1) reads data to be migrated which has been acquired from the SDS #y(301) to the storage space 280-0 associated with the volume LV0 to which the second volume address belongs. The management program 150 changes the space address (the space address described in the second address map) mapped to the second volume address from the first space address of the source to be read in (m1) to the second space address of the write destination in (m2).

It is to be noted that information with respect to which second volume addresses at which the writing has been completed may be managed on the basis of, for example, a bit map composed of a plurality of bits corresponding to the plurality of respective second volume addresses. For example, the management program 150 (or the SDS client program 260y-1) updates the bit corresponding to the second volume address at which writing in data copy or writing according to the I/O to volume LV0 has been performed to “1” among the plurality of second volume addresses. In this way, the second volume address corresponding to the bit “0” is the second volume address at which writing has not been completed.

When the I/O is performed to the volume LV0 by the AP 325, for example, the following process is performed.

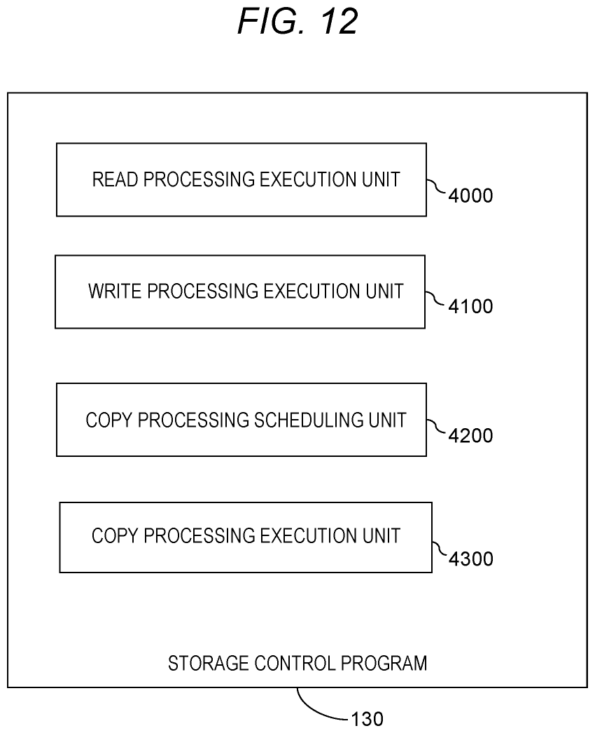

That is, when the I/O to volume LV0 is reading, the read processing execution unit (see FIG. 12) accepts the reading and determines whether the data copy has been completed with respect to the second volume address of the read source of the reading based on the above bit map. When the data copy is incomplete, the read processing execution unit identifies, as a space address corresponding to the second volume address of the read source, the first space address from the second address map, and gives a reading instruction designating the first space address to the SDS client program 260y-1. For this reason, the SDS client program 260y-1 transmits a read request designating the first space address to the SDS #y(301), so that the SDS client program 260y-1 acquires data to be read, and the data to be read is returned from the SDS client program 260y-1 to the read processing execution unit. On the other hand, when the data copy has been completed, the read processing execution unit identifies, as a space address corresponding to the second volume address of the read source, a second space address from the second address map. The read processing execution unit uses the second space address to acquire data to be read from the storage space 280-0.

In the case of writing to the volume LV0, the write processing execution unit (see FIG. 12) accepts the writing and determines whether the data copy has been completed with respect to the second volume address of the write destination of the writing, based on the bit map. When data copy is incomplete, the write processing execution unit maps an empty second space address to the second volume address, and writes data to the storage space 280-0 using the second space address. Also, the write processing execution unit changes the space address corresponding to the second volume address in the second address map to the second space address of the write destination. In addition, the write processing execution unit updates to “1” the bit corresponding to the second volume address among the above bit map. On the other hand, when the data copy has been completed, the write processing execution unit identifies the second space address corresponding to the second volume address of the write destination from the second address map, and writes the data in the storage space 280-0 using the second space address.

In the information system according to this embodiment, it is possible to provide the volume possessed by the other SDS systems #y(301) as its own (SDS #x(300)) volume to the AP server 105 using the virtualization function of the SDS #x(300). In the following description, the functions mainly performed by SDS #x(300) will be described. Therefore, in order to avoid confusion of the volume that SDS #x(300) provides to the AP server 105 with volumes of other SDS (SDS #y(301)), the volume that SDS #x(300) provides to the AP server 105 is referred to as “logical volume”. In FIG. 3, the storage space 280-1 of the SDS #y(301) is provided as the volume LV0 of the SDS #x(300) according to the virtualization function of the SDS #x(300).

Next, an example of a method of managing a storage area in SDS #x according to the present embodiment will be described.

The SDS #x(300) does not directly provide the storage space of the storage device 220 to the initiator (such as the AP server 105), but defines a storage space as a logical volume that is a different storage space. The SDS #x(300) can define a plurality of logical volumes. A unique identification number is assigned to each logical volume within SDS #x(300), which is referred to as a logical volume identifier (or logical volume ID). The “logical volume” may be the volume LV0 generated by the SDS client program 260y-1, or may be the storage space 280-0 associated with the volume LV0. Hereinafter, in order to simplify the explanation, it is assumed that an example of the logical volume is the volume LV0.

The SDS #x can provide the logical volume defined by the Thin Provisioning function directly (without via the SDS client program 260) or indirectly (via the SDS client program 260) to the AP server 105. In the latter case, instead of the storage space 280-0, which is the logical volume as an example, the volume LV0 is provided to the AP server 105. SDS #x has a volume virtualization function, and can define the logical volume using a storage area of another storage apparatus.

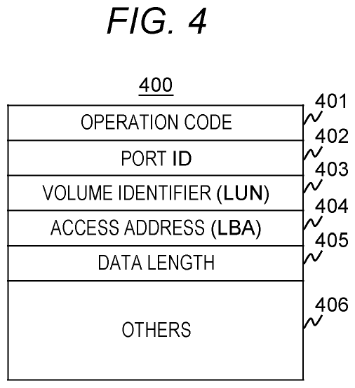

In FIG. 4, in this embodiment, an example of the format of the I/O request (read request or write request) issued from the initiator (AP server 105 or the like) to the SDS 100 will be illustrated. An I/O request 400 includes at least an operation code 401, a port ID 402, a volume identifier 403, an access address 404, and a data length 405.

The operation code 401 stores the type of I/O request. For example, when the AP server 105 issues a read request, information indicating that it is a read request is stored in the operation code 401.

The port ID 402 is an identifier of the port 190 of the SDS 100 having the volume to be accessed. An iSCSI Name (in the case of the network where the network 120 transmits a TCP/IP protocol), a PORT ID (in the case of the network where the network 120 is formed of a fiber channel) and the like are used as the identifier of the port 190.

The volume identifier 403 is an identifier of a volume to be accessed, and includes, for example, an LUN (Logical Unit Number) or the like. The access address 404 and the data length 405 are information indicating the range to be accessed in the volume to be accessed. When “A” is included in the access address 404 and “B” is included in the data length 405, it means that the area of size B beginning with address A is the range to be accessed The unit of information stored in the access address 404 or the data length 405 is not limited to a specific one. For example, the number of blocks (one block is, for example, an area of 512 bytes) is stored in the data length 405, and an LBA (Logical Block Address) may be stored in the access address 404.

The I/O request 400 may include information other than the information described above (in FIG. 4, indicated as “others 406”). For example, when the I/O request is a write request, data to be written is added after the data length 405.

Next, an example of the Thin Provisioning function and a method of managing a storage area in SDS #x(300) will be described.

The logical volume formed by the Thin Provisioning function is configured such that the storage device 220 possessed by its own (that is, by SDS #x(300)) is used as a storage area. However, at the beginning (immediately after this logical volume is defined), the storage area used that stores the data to be written for each address on the logical volume is not fixed. The SDS #x(300) determines the storage area of the storage device 220, which is the storage destination of the data to be written in the range to be written (the range designated by the write request) for the first time when a write request to the logical volume is accepted. Hereinafter, the process of determining the storage destination of the data to be written in the range to be written (the range designated by the write request) is expressed as “allocate”.

The storage area allocated to the logical volume by the Thin Provisioning function will be described. Even if any one of the plurality of storage devices 220 fails, the SDS #x(300) has a Redundant Arrays of Inexpensive/Independent Disks/Device (RAID) function capable of recovering data in the storage device 220. SDS #x(300) constructs one RAID using some (for example, four, eight, etc.) storage devices 220 in SDS #x(300). A set of storage devices 220 constituting the RAID is referred to as a storage device group. Also, in the following description, for simplicity of explanation, it is assumed that the storage space 280 (for example, 280-0) is a storage space provided by the storage device group. Therefore, the storage space 280 may be referred to as a “storage device group 280”. In the SDS #x(300) according to this embodiment, one storage device group 280 is composed of the same type of storage devices 220. The SDS #x(300) also manages each storage area of the storage device group 280 as a storage space which can be identified by the one-dimensional address.

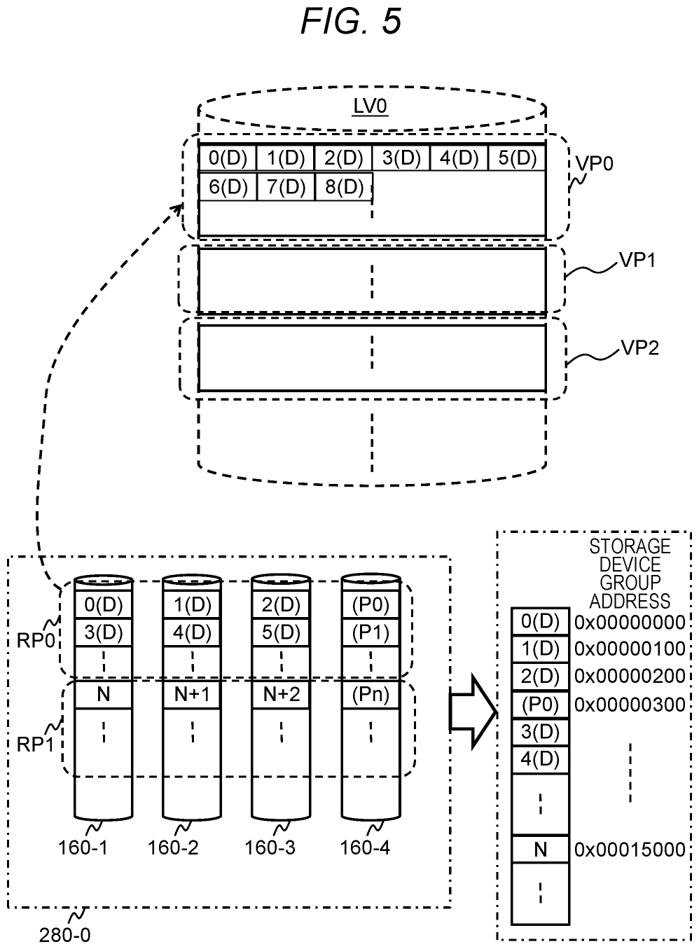

With reference to FIG. 5, the relationship between the logical volume formed by the Thin Provisioning function and the storage device group 280 will be described. In order to manage the storage area allocated to the logical volume (“LV0” in the figure), the SDS #x(300) manages the logical volume for each area of a predetermined size which is a plurality of virtual pages (in FIG. 5, VP0, VP1, VP2). When allocating a storage area to a logical volume, the SDS #x(300) allocates a storage area for each virtual page. Each virtual page is assigned a unique identification number within the logical volume. This identification number is referred to as a virtual page number (or may be referred to as “virtual page #”). A virtual page whose virtual page number is n is denoted as “virtual page #n”.

The virtual page is a concept used only for management of the storage space of the logical volume inside SDS #x(300). Upon accessing the storage area of the logical volume, the initiator of the AP server 105 or the like identifies the storage area to be accessed using an address such as an LBA (Logical Block Address). When the AP server 105 issues an access request to the logical volume, the SDS #x(300) converts the LBA designated by the AP server 105 into a virtual page number and a relative address in the virtual page (an offset address from the head of the virtual page). This conversion can be implemented by dividing the LBA by the virtual page size. Assuming that the size of the virtual page is P (MB), the area for P (MB) from the head position of the logical volume is managed as virtual page #0, and the area corresponding to the next P (MB) is managed as virtual page #1. Similarly, the areas of P (MB) after that are managed as virtual pages #2, #3, . . .

Immediately after SDS #x(300) defines the logical volume, no physical storage area is allocated to each virtual page. Only when accepting the write request to the virtual page from the AP server 105, the SDS #x(300) allocates a physical storage area to the virtual page. The physical storage area allocated to the virtual page is referred to as a real page. The real page is a storage area on the storage device group 280. In FIG. 5, the real page RP0 is allocated to the virtual page #0 (VP0).

The real page is an area formed using the storage areas of the plurality of storage devices 220 of the storage device group 280. In FIG. 5, reference numerals 160-1, 160-2, 160-3, and 160-4 indicate the storage areas of the respective storage devices 220. Further, the RAID level of the storage device group 280 illustrated in FIG. 5 is a RAID 4 (In the type of data redundancy scheme in RAID technology, generally, there are six types of RAID levels from RAID level 1 (RAID 1) to RAID level 6 (RAID 6).), and a RAID composed of three data drives and one parity drive. However, the RAID other than RAID 4 (for example, RAID 5, RAID 6, etc.) may be used as the RAID level of the storage device group 280.

SDS #x(300) divides the storage area of each storage device 220 belonging to the storage device group 280 into a plurality of fixed sized storage areas called stripe blocks and manages it. For example, in FIG. 5, each region described as 0(D), 1(D), 2(D), . . . or P0, P1, . . . represents a stripe block.

In FIG. 5, among the stripe blocks, the stripe blocks described as P0, P1, . . . are stripe blocks storing redundant data (parity) generated by the RAID function, and is referred to as “parity stripe”. On the other hand, the stripe blocks described as 0(D), 1(D), 2(D), . . . are stripe blocks storing data written from the AP server 105 (data that is not redundant data). This stripe block is referred to as a “data stripe”. The parity stripe stores redundant data generated using a plurality of data stripes.

Hereinafter, a set of the parity stripe and the data stripe used to generate redundant data stored in the parity stripe is referred to as a “stripe line”. In the example shown in FIG. 5, for example, redundant data (parity) generated using data stripes 0(D), 1(D) and 2(D) is stored in the parity stripe P0, and data stripes 0(D), 1(D), 2(D) and parity stripe P0 belong to the same stripe line.

That is, each stripe block belonging to one stripe line exists at the same position (address) on the storage apparatus (160-1, 160-2, 160-3, 160-4). However, in another embodiment, a configuration in which each stripe block belonging to the same stripe line exists at a different address on the storage device 220 may be adopted. As shown in FIG. 5, the real page (for example RP0, RP1) is an area composed of one or more stripe lines.

The SDS #x(300) also manages each storage area (block) of the storage device group 280 as a storage space that can be identified by a one-dimensional address. Hereinafter, this storage space is referred to as “storage space of storage device group”, and the address on this storage space is referred to as an “address of a storage device group” or a “storage device group address”. An example of the storage device group address is shown in FIG. 5. As shown in FIG. 5, the storage space of the storage device group is a storage space in which each stripe in the storage device group 280 is sequentially arranged one by one. The storage device group address of the head stripe block in the storage device group is set to 0, and subsequently the address is attached to each stripe block as shown in FIG. 5, for example. The address of the storage device group is used to manage the correspondence between the real page and the storage area on the storage device group 280.

Also, when a real page is allocated to a virtual page, only data stripe (0(D), 1(D) etc.) is allocated, and no parity stripe is allocated. For this reason, the total size of the area where the write data is stored on the real page is the same as the size of the virtual page. That is, (the size of the real page−the size of the parity storage area)=the virtual page size. Although only the configuration example of RAID 4 is shown in FIG. 5, for example, when the RAID type of the storage device group 280 is RAID 1, the real page size is twice the virtual page size.

Note that the SDS #x(300) may not necessarily support the RAID function. In this case, the parity stripe is not defined, and the size of the real page and the size of the virtual page are the same.

The relationship (mapping) between each area in the virtual page and each area in the real page is as shown in FIG. 5. That is, the area (0(D), 1(D), 2(D)) obtained by removing the parity from the top stripe of the real page is allocated to the head area of the virtual page. Subsequently, the areas (3(D), 4(D), 5(D), . . . ) obtained by removing the parity from the second and subsequent stripes of the real page are sequentially allocated to the areas of the virtual page.

In this way, since the mapping of each area in the virtual page and each area in the real page is regularly performed, the SDS #x can uniquely calculate the storage device 220 associated with the access position and the area (data stripe) in the storage device 220 by obtaining the virtual page number and the relative address in the virtual page (the offset address from the virtual page head) from the access position (LBA) on the logical volume designated by the access request from the AP server 105. In addition to the data stripe associated with the access position, the parity stripe belonging to the same stripe line as the data stripe is uniquely determined. However, the mapping of each area in the virtual page and each area in the real page is not limited to the mapping method described here.

The real page allocated to each virtual page in one logical volume is not necessarily limited to the real page in the same storage device group 280. The real page allocated to the virtual page #0 and the real pages allocated to the virtual page #1 may be real pages in different storage device groups 280.

Also, the real page allocated to the virtual page must be a real page that has not yet been allocated to another virtual page. A real page that is not allocated to a virtual page is referred to as a “free page” or a “free real page”.

Here, although the Thin Provisioning function of the SDS #x(300) has been described, the other storage apparatuses (SDS #y(301) etc.) in the information system according to this embodiment may not have these functions.

Management information used by the storage control program 130 of the SDS #x(301) in the present embodiment will be explained.

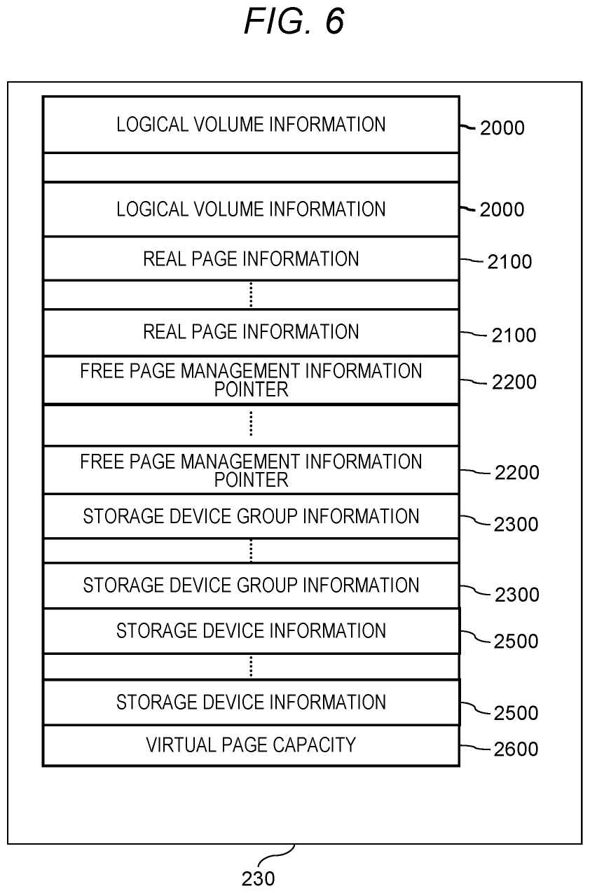

FIG. 6 shows main information included in the management information 230 of the SDS #x(301).

The management information 230 includes logical volume information 2000, real page information 2100, free page management information pointer 2200, storage device group information 2300, storage device information 2500, virtual page capacity 2600. However, other information may be included in the management information 230.

The logical volume information 2000 is management information such as a configuration of a logical volume (for example, a mapping of a virtual page and a real page), and the logical volume information 2000 is defined for each logical volume of the SDS #x(300). Therefore, when L logical volumes are defined in the SDS #x(300), there are L pieces of logical volume information 2000 in the management information 230. Hereinafter, a logical volume whose attribute information is managed by a certain logical volume information 2000 is referred to as a “logical volume to be managed”.

The real page information 2100 is information for managing real pages, and the real page information 2100 exists for each real page (there are as many pieces of real page information 2100 as the number of real pages possessed by the SDS #x(300) in the management information 230). Hereinafter, a real page whose attribute information is managed by certain real page information 2100 will be referred to as a “real page to be managed”.

The storage device group information 2300 is information on the configuration of the storage device group 280 included in the SDS #x(300). The storage device group information 2300 exists for each storage device group 280. Hereinafter, a storage device group whose attribute information is managed by a certain storage device group information 2300 will be referred to as a “storage device group to be managed”.

The storage device information 2500 is information on the storage device 220 possessed by the SDS #x(300), and exists for each storage device 220. Hereinafter, a storage device whose attribute information is managed by a certain storage device information 2500 will be referred to as a “storage device to be managed”.

The free page management information pointer 2200 is information for managing free real pages, and one free page management information pointer 2200 exists for one storage device group 280.

The virtual page capacity 2600 is information indicating the size of the virtual page. In the present embodiment, the virtual page size of each logical volume is assumed to be equal. Therefore, there is only one virtual page capacity 2600 in the management information 230.

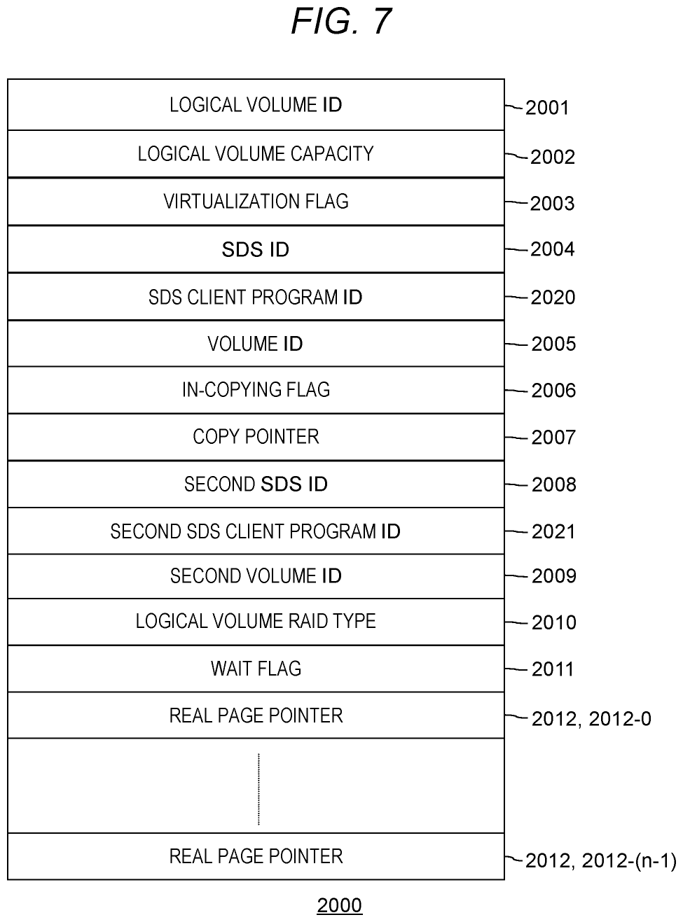

FIG. 7 is a diagram showing the format of the logical volume information 2000.

The logical volume information 2000 includes a logical volume ID 2001, a logical volume capacity 2002, a virtualization flag 2003, an SDS ID 2004, an SDS client program ID 2020, a volume ID 2005, an in-copying flag 2006, a copy pointer 2007, a second SDS ID 2008, a second SDS client program ID 2021, a second volume ID 2009, a logical volume RAID type 2010, a wait flag 2011, and real page pointer 2012.

The logical volume ID 2001 indicates an identifier of the logical volume to be managed. In this embodiment, an example in which an LUN (Logical Unit Number) is used as the identifier of the logical volume will be described. However, the identifier of the logical volume may be an identifier which is unique within the SDS 100, and identifiers other than LUN may be used. In this embodiment, the identifier may be referred to as “ID” in some cases.

The logical volume capacity 2002 is a capacity of the logical volume to be managed.

Either 0(off) or 1(on) is stored in the virtualization flag 2003. When the logical volume to be managed is formed by using the volume of another storage apparatus (SDS 100 other than the SDS #x(300)) (that is, in the case of a logical volume defined using the virtualization function), the virtualization flag 2003 is set to ON(1). When the virtualization flag 2003 of the logical volume information 2000 is ON, the SDS ID 2004 and the volume ID 2005 represent the identifier of the SDS 100 having the volume mapped to the logical volume to be managed and the identifier of the volume, respectively. Further, in this embodiment, it is assumed that the identifier of the port 190 of the SDS 100 is used as the identifier of the SIDS 100. For this reason, the identifier of the port 190 of the SDS 100 is stored in the SDS ID 2004 and the second SDS ID 2008 described later. However, information other than this may be used as the identifier of the SDS 100.

The in-copying flag 2006 and the second SDS ID 2008 are used when the logical volume is a logical volume defined by using the virtualization function. The SDS #x(300) may perform copy process of the logical volume defined by using the virtualization function by causing a copy processing execution unit 4300 to be described later to function. In this copy processing, the data of the volume mapped to the logical volume is copied to another location (storage device 220 in SDS #x(300) or another SDS 100). The in-copying flag 2006 is information indicating whether data of a volume mapped to a logical volume is being copied to another location. When the in-copying flag 2006 is “ON” (1), it means that the copy processing is in progress. The copy pointer 2007 is information used in the copy processing, and details will be described later.

The second SDS ID 2008 represents the identifier of the copy destination SDS 100 of the data of the volume mapped to the logical volume. The copy destination SDS 100 may be the own device (that is, SDS #x(300)). When the second SDS ID 2008 is an identifier of the SDS #x(300), it means that the copy processing execution unit 4300 is copying the data of the volume mapped to the logical volume onto the storage device 220 of the SDS #x. Conversely, when the second SDS ID 2008 is not an identifier of the SDS #x, it means that the copy destination of the data of the volume mapped to the logical volume is the volume of another SDS 100. When the copy destination of the data is the volume of another SDS 100, the second volume ID 2009 indicates the identifier of the volume of the data copy destination.

Information on the RAID configuration of the storage device group 280 having the teal page allocated to the logical volume stored in the logical volume RAID type 2010. Specifically, in the present embodiment, the RAID configuration is information including the RAID level of the RAID (storage device croup 280) and the number of storage devices 220 constituting the storage device group 280.

The wait flag 2011 is information indicating that there is a read process or a write process in the waiting state in the logical volume to be managed.

The real page pointer 2012 is information on the correspondence (mapping) between the virtual page and the real page of the logical volume to be managed. The pointer (an address on the main memory 210) to the page management information (real page information 2100 to be described later) of the real page allocated to the virtual page is included in the real page pointer 2012.

The number of the real page pointers 2012 included in one logical volume information 2000 is the number of virtual pages of the logical volume to be managed (equal to the number obtained by dividing the logical volume capacity 2002 by the virtual page capacity 2600). For example, if the number of virtual pages of the logical volume is n, there are n real page pointers 2012 in the logical volume information 2000 of the logical volume. In FIG. 7, the real page pointer 2012 of the virtual page #p (p is an integer of 0 or more) is expressed as “real page pointer 2012-p”.

Note that the moment to allocate a real page to a virtual page is not when the logical volume is defined, but when data writing from the AP server 105 for virtual pages is performed. Therefore, the real page pointer 2012 of the virtual page to which data has not been written yet is NULL (invalid value, for example, the value of “−1” or the like).

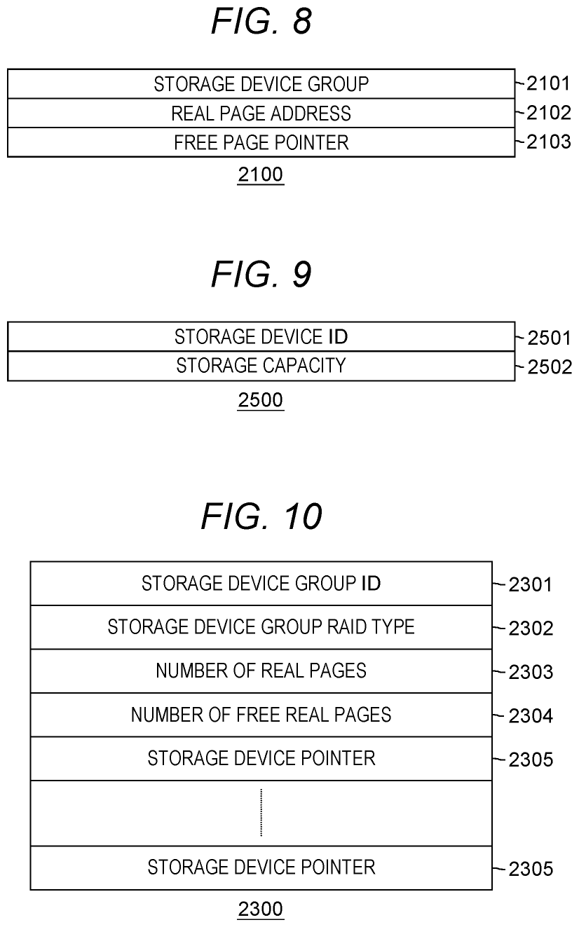

FIG. 8 is a diagram showing the format of real page information 2100.

As mentioned above, the real page is a storage area defined in the storage device group 280. The real page information 2100 is information storing information identifying the storage device group 280 in which the real page exists and the position in the storage device group 280, and specifically, a storage device group 2101, a real page address 2102, and a free page pointer 2103.

The storage device group 2101 represents an identifier (referred to as a storage device group ID) of the storage device group 280 to which the real page to be managed belongs. The real page address 2102 is information indicating the position where the real page to be managed exists. Since the real page exists in the storage device group 280, the information used for the real page address 2102 is the address of the storage device group 280. Specifically, the address of the head area of the real page to be managed is stored in the real page address 2102. Description will be made with reference to FIG. 5. In FIG. 5, for example, since the stripe block N is positioned at the head of the real page RP1, and the address (storage group address) of the stripe block N is “0x00015000” (“0x” indicates that the numerical value is in hexadecimal notation), “0x00015000” is stored in the real page address 2102 of the real page information 2100 of the real page RP1.

The free page pointer 2103 is used when the real page to be managed is not allocated to the virtual page. Details will be described later. When the real page is allocated to a virtual page, NULL is stored in the free page pointer 2103 of the real page.

FIG. 9 is a diagram showing the format of the storage device information 2500.

The storage device information 2500 is information recording attribute information of the storage device 220, and includes information of a storage device ID 2501 and a storage capacity 2502. The storage device ID 2501 is an identifier of the storage device to be managed. The storage capacity 2502 is a capacity of the storage device to be managed.

FIG. 10 is a diagram showing the format of the storage device group information 2300.

The storage device group information 2300 has information of a storage device group ID 2301, a storage device group RAID type 2302, the number of real pages 2303, the number of free real pages 2304, and storage device pointer 2305. The storage device pointer 2305 is a pointer to management information (storage device information 2500) of the storage device 220 belonging to the storage device group to be managed. When the storage device group 280 is composed of N storage devices 220, the storage device group information 2300 of the storage device group 280 has N storage device pointers 2305.

The storage device group ID 2301 is an identifier of the storage device group to be managed. The storage device group RAID type 2302 is the RAID type of the storage device group to be managed. The contents of information stored in the storage device group RAID type 2302 is the same as that mentioned in the description of the logical volume RAID type 2010. The number of real pages 2303 and the number of free real pages 2304 are the total number of real pages of the storage device group to be managed and the number of free real pages respectively.

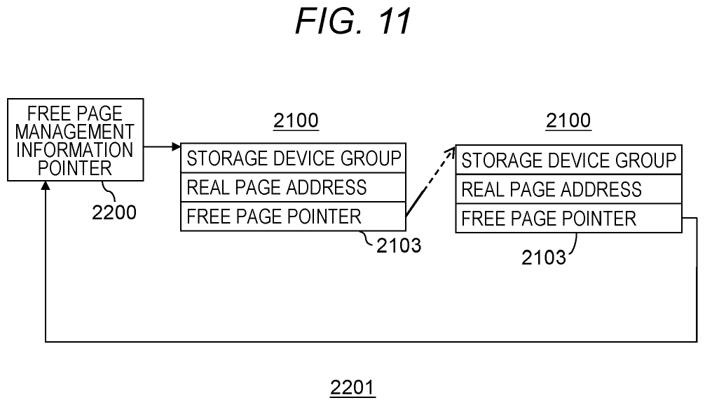

Next, the free page management information pointer 2200 will be described. The free page management information pointer 2200 is information provided for each storage device group 280. FIG. 11 shows a set of free real pages managed by the free page management information pointer 2200. This structure is referred to as a free page management information queue 2201. Also, the real page information 2100 corresponding to the free real page among the real page information 2100 is referred to as the free real page information 2100. The free page management information pointer 2200 indicates an address of the head free real page information 2100. Next, the free page pointer 2103 in the head real page information 2100 indicates the next free real page information 2100. In FIG. 11, although the free page pointer 2103 of the last free real page information 2100 indicates the free page management information pointer 2200, it may indicate NULL.

When accepting a write request to a virtual page to which no real page is allocated in the area on the virtual volume, the SDS #x(300) selects any one of the storage device groups 280 whose RAID configuration is the same as the logical volume RAID type 2010 f the virtual volume. When there are a plurality of selectable storage device groups 280, for example, the SDS #x(300) selects the storage device group 280 having the largest number of free real pages, and searches the free real page from the free page management information queue 2201 of the storage device group 280 to allocate it to the virtual page.

The operation of the SDS (300) is mainly implemented by the processor 200 in the SDS #x(300) executing the storage control program 130 stored in the main memory 210. The storage control program 130 includes a plurality of program modules (hereinafter abbreviated as “module”). FIG. 12 shows each module related to the explanation of the present embodiment among modules included in the storage control program 130. The modules related to the present embodiment include a read processing execution unit 4000, a write processing execution unit 4100, a copy processing scheduling unit 4200, and the copy processing execution unit 4300.

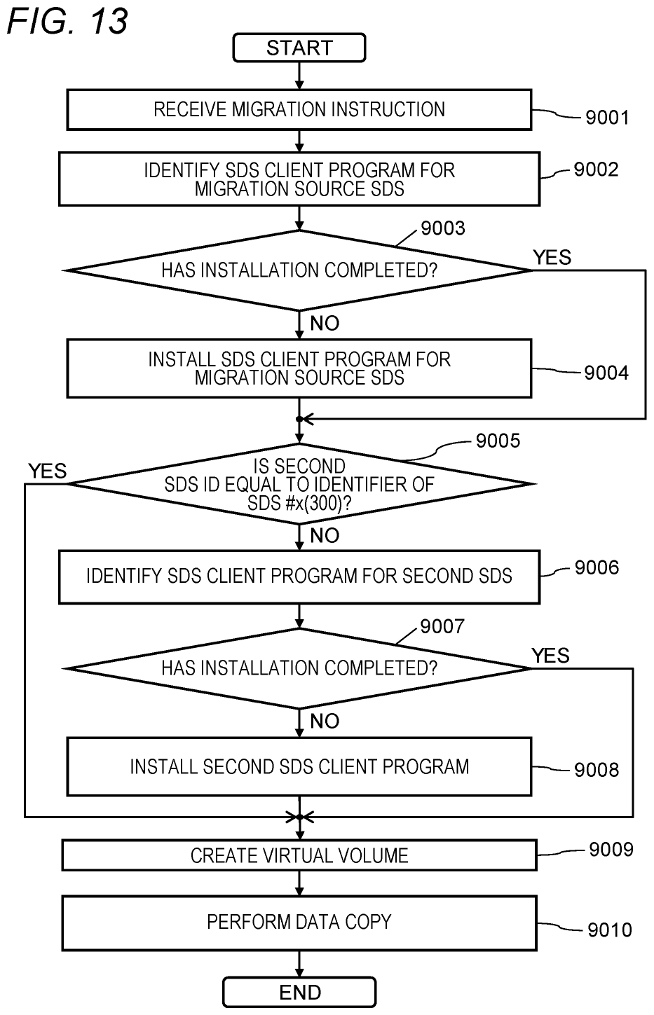

FIG. 13 is a diagram showing the flow of the SDS migration processing.

Step 9001: The management program 150 receives a migration instruction from the management server 140.

Step 9002: The management program 150 identifies the SDS client program 260y for SDS #y (for migration source SDS) using the program ID designated by the migration instruction as a key.

Step 9003: The management program 150 determines whether the SDS client program. 260y identified in S9002 has been installed in the SDS #x(300).

Step 9004: When the determination result of step 9003 is No, the management program 150 calls the install program 250, so that the SDS client program 260y identified in S9002 is installed in the SDS #x(300).

Step 9005: When the determination result of step 9003 is Yes, or after step 9004, the management program 150 determines whether the second SDS ID 2008 is equal to the identifier of the SDS #x(300).

Step 9006: When the determination result of step 9003 is No, the copy destination (migration destination) is an SDS different from the SDS #x(300) (for example, externally connected storage connected to the SDS #x(300) and providing a storage space to the SDS #x(300)). The management program 150 identifies the SDS client program for the different SDS.

Step 9007: The management program 150 determines whether the SDS client program identified in S9006 has been installed in the different SDS.

Step 9008: When the determination result of step 9007 is No, the management program 150 calls the install program 250, so that the SDS client program identified in S9006 is installed in the different SDS.

Step 9009: When the determination result of step 9005 is Yes, when the determination result of step 9007 is Yes, or after step 9008, the management program 150 causes the SDS client program 260y-1 to generate a virtual volume (virtual logical volume) LV0.

Step 9010: The management program 150 performs data copy from the storage space 280-1 to the storage space 280-0 via the volume LV0.

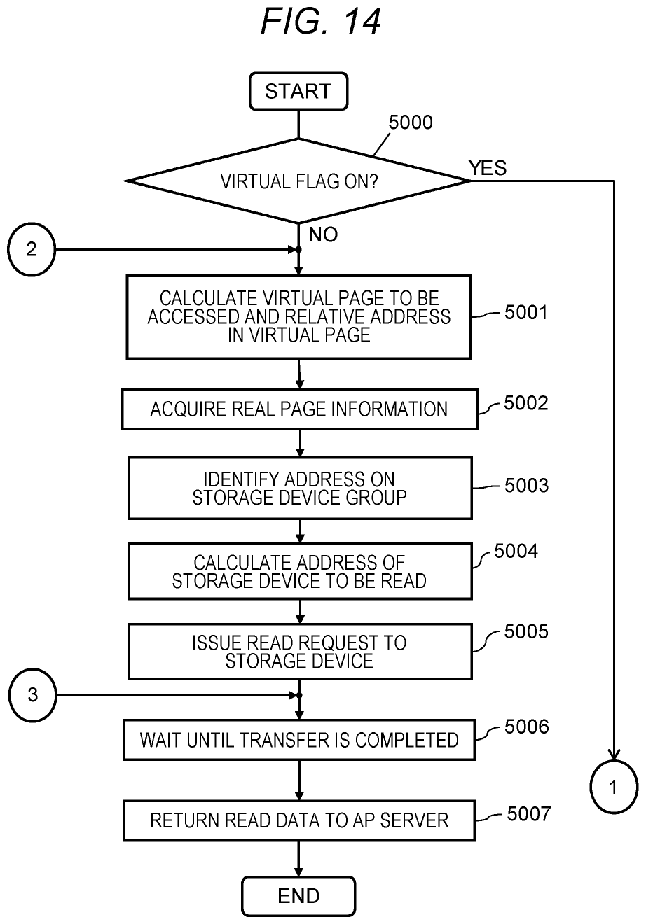

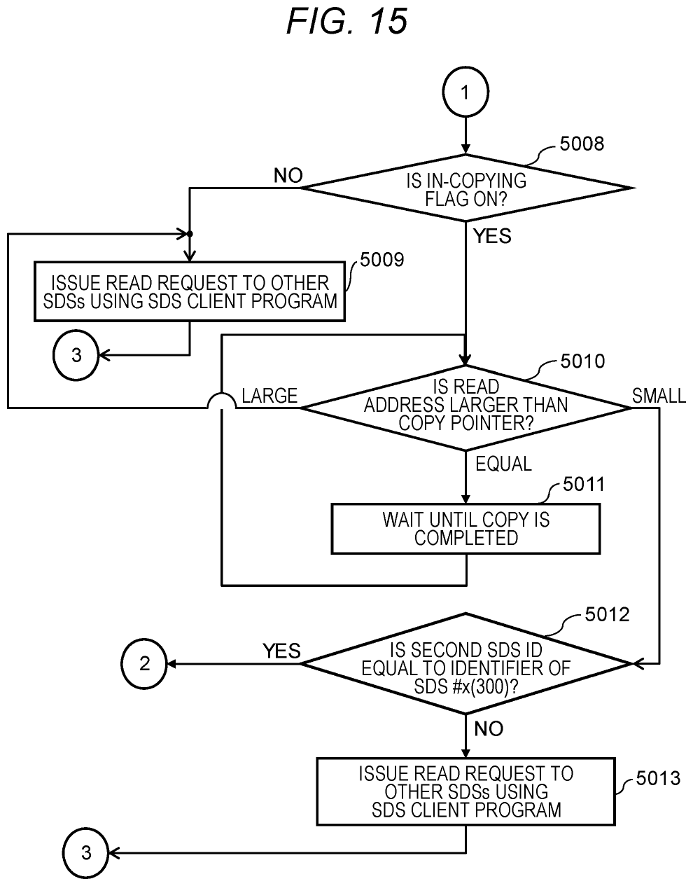

FIG. 14 and FIG. 15 are diagrams showing the processing flow of the read processing execution unit 4000.

The read processing execution unit 4000 is performed when the SDS #x(300) accepts a read request from the AP server 105. In this embodiment, in order to avoid a complicated explanation, an example in which the area to be read designated by the read request received from the AP server 105 is contained within one virtual page will be described.

Step 5000: The read processing execution unit 4000 refers to the logical volume information 2000 of the logical volume to be read designated by the read request, and determines whether the virtualization flag 2003 is ON. If the virtualization flag 2003 is ON, next, step 5008 (FIG. 15) is performed, and if it is OFF, the read processing execution unit 4000 then performs step 5001.

Step 5001: The read processing execution unit 4000 calculates the virtual page # of the virtual page including the address to be read and the relative address in the virtual page from the address to be read designated by the received read request.

Step 5002: In this step, the read processing execution unit 4000 acquires, from the real page pointer 2012 of the logical volume information 2000, the real page information. 2100 corresponding to the real page allocated to the virtual page to be read.

Step 5003: The read processing execution unit 4000 identifies the storage device group 280 in which the real page to be read exists, and the address of the storage device group 280. These are obtained by referring to the storage device group 2101 and the real page address 2102 of the real page information 2100 acquired in step 5002.

Step 5004: The read processing execution unit 4000 calculates the relative address in the real page to be accessed by the request based on the relative address in the virtual page obtained in step 5001 and the storage device group RAID type 2302. Then, the read processing execution unit 4000, based on the calculated relative address in the real page, the storage device group RAID type 2302 and the storage device pointer 2305, identifies the storage device 220 to be read and identifies the read destination address of the storage device 220.

Step 5005: The read processing execution unit 4000 issues a read request to the storage device 220 identified in step 5004.

Step 5006: The read processing execution unit 4000 waits until data is returned from the storage device 220.

Step 5007: The read processing execution unit 4000 transmits the data received from the storage device 220 to the AP server 105 and completes the process.

Step 5008: The read processing execution unit 4000 determines whether the in-copying flag 2006 is ON. If it is ON, step 5010 is then performed.

Step 5009: When the in-copying flag 2006 is OFF, data copy is incomplete with respect to the volume of the SDS 100 identified by the SDS ID 2004 and the volume ID 2005, and the address to be read received from the AP server 105. In this case, the read processing execution unit 4000 identifies, as a space address corresponding to the address to be read, the first space address from the second address map, and gives a reading instruction designating the first space address to the SDS client program 260y-1. Thereafter, the read processing execution unit 4000 waits until data is transmitted (step 5006), then performs step 5007, and ends the process. That is, the SDS client program 260y-1 transmits a read request designating the first space address to the SDS #y(301) to acquire data to be read, so that the data to be read is returned from the SDS client program 260y-1 to the read processing execution unit 4000. The read processing execution unit 4000 transmits the received data to the AP server 105, and completes the process.

Step 5010: When the in-copying flag 2006 is ON, the read processing execution unit 4000 determines whether the address designated by the read request received from the AP server 105 is larger than the copy pointer 2007, and if the address designated by the read request received from the AP server 105 is larger than the copy pointer 2007, the read processing execution unit 4000 performs step 5009. Since the processing after execution of step 5009 is as described above, the explanation here is omitted.

Step 5011: When the address designated by the read request received from the AP server 105 is equal to the copy pointer 2007, it means that the area to be read is being copied. Therefore, the read processing execution unit 4000 sets the wait flag 2011 of the logical volume to be read to ON (1), and waits for the completion of the copy process. After the copying process is completed, the read processing execution unit 4000 again performs step 5010.

Step 5012: When the address designated by the read request received from the AP server 105 is smaller than the copy pointer 2007, the read processing execution unit 4000 determines whether the second SDS ID 2008 is equal to the identifier of the SDS #x(300). If equal, the read processing execution unit 4000 performs step 5001.

Step 5013: If the second SDS ID 2008 is not equal to the identifier of the SDS #x(300), the read processing execution unit 4000 issues a read request to the volume of the SDS 100 identified by the second SDS ID 2008 and the second volume ID 2009 via the network 120. Thereafter, the read processing execution unit 4000 performs step 5006 and step 5007, and ends the process.

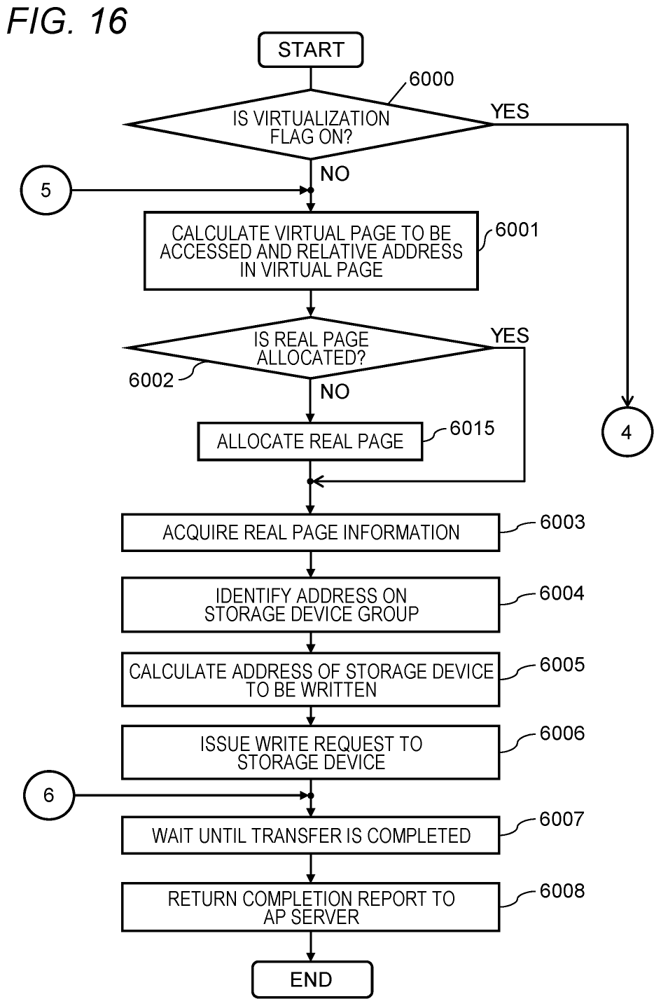

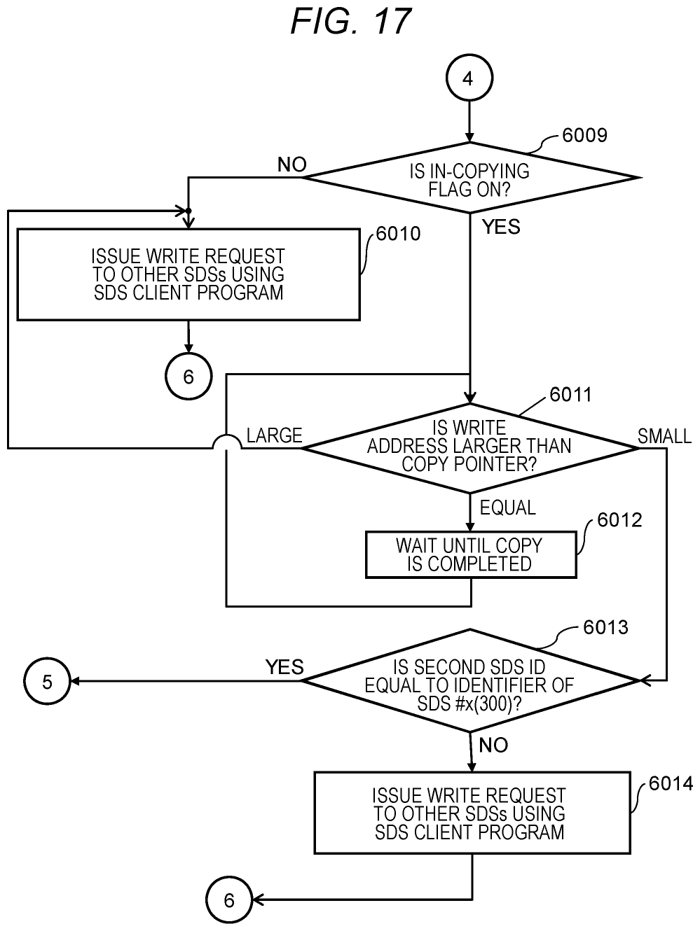

FIGS. 16 and 17 are diagrams showing the processing flow of the write processing execution unit 4100.

The write processing execution unit 4100 is performed when the SDS #x(300) accepts a write request from the AP server 105. In this embodiment, in order to avoid a complicated explanation, an example in which the area to be written designated by the write request received from the AP server 105 is contained within one virtual page will be described.

Step 6000: The write processing execution unit 4100 refers to the logical volume information 2000 of the logical volume to be written specified by the write request, and determines whether the virtualization flag 2003 is ON. If the virtualization flag 2003 is ON, next, step 6009 is performed, and if it is OFF, the write processing execution unit 4100 then performs step 6001.

Step 6001: The write processing execution unit 4100 calculates, from the address to be written designated by the received write request, the corresponding virtual page and the relative address in the virtual page to be accessed.

Step 6002: In this step, the write processing execution unit 4100 determines whether the real page is allocated to the virtual page to be written. If no real page is allocated to the virtual page, step 6015 is performed, and if it is allocated, step 6015 is skipped.

Step 6015: Here, a real page is allocated to the virtual page to be written. Allocation of the real page to the virtual page is performed as follows. The write processing execution unit 4100 refers to the logical volume RAID type 2010 of the logical volume information 2000, and the storage device group RAID type 2302, the number of free real pages 2304, etc. of the storage device group information 2300, and determines which storage device group's 280 real page is to be allocated. Next, the write processing execution unit 4100 refers to the free page management information queue 2201 of the selected storage device group 280 so that the real page pointer 2012 of the virtual page to be written indicates the free real page information 2100 located at the head of the free page management information queue 2201 (free real page information 2100 indicated by the free page management information pointer 2200).

The write processing execution unit 4100 updates the free page management information pointer 2200 so that the free page management information pointer 2200 indicates the second real page information 2100 (real page information 2100 indicated by the free page pointer 2103 in the real page information 2100 of the real page allocated to the virtual page) in the free page management information queue 2201, and further, the free page pointer 2103 in the real page information 2100 of the real page allocated to the virtual page is changed to NULL. Also, the number of free real pages 2304 of the storage device group information 2300 corresponding to the real page is reduced. After the real page is allocated to the virtual page, step 6003 is performed.

In this embodiment, although the example in which the allocation of the real page to the virtual page is performed when the SDS 100 accepts the write request has been described, this allocation process may not be necessarily performed when the write request is accepted. This allocation process may be performed by the time the SDS 100 stores data in the storage device 220.

Step 6003: The write processing execution unit 4100 acquires the real page information 2100 of the real page allocated to the virtual page to be written by referring to the real page pointer 2012 of the logical volume information 2000.

Step 6004: the write processing execution unit 4100 identifies, from the acquired storage device group 2101 and the acquired real page address 2102 of the real page information 2100, the storage device group 280 in which the real page to be written exists and the address on the storage device group 280. This is the same process as step 5003.

Step 6005: the write processing execution unit 4100 calculates, from the relative address in the virtual page and the storage device group RAID type 2302 obtained in step 6001, the relative address in the real page to be accessed by the request. The write processing execution unit 4100 determines, from the calculated real page relative address, the storage device group RAID type 2302 and the storage device pointer 2305, the storage device 220 of the write destination and the write destination address on the write destination storage device 220. The write processing execution unit 4100 also refers to the storage device group RAID type 2302 to generate necessary redundant data by a known method, and determines the storage device 220 that stores the redundant data and the address thereof.

Step 6006: The write processing execution unit 4100 uses the address of the storage device 220 determined in step 6005 to generate a write request instructing storage of data, and issues it to the storage device 220. The write processing execution unit 4100 issues a write request to the storage device 220 of the storage destination of the redundant data, and also writes redundant data.

Step 6007: After issuing the write request, the write processing execution unit 4100 waits until a response is returned from the storage device 220.

Step 6008: The write processing execution unit 4100 transmits a completion report to the AP server 105.

Step 6009: The write processing execution unit 4100 determines whether the in-copying flag 2006 is ON. If it is ON, step 6011 is then performed.

Step 6010: When the in-copying flag 2006 is OFF, the write processing execution unit 4100 designates the received relative address and length to the volume of the SDS 100 identified by the SDS ID 2004 and the volume ID 2005 to issue the write request via the network 120. Thereafter, the write processing execution unit 4100 performs step 6007 and step 6008, and ends the process.

Step 6011: When the in-copying flag 2006 is ON, the write processing execution unit 4100 determines whether the address designated by the write request received from the AP server 105 is larger than the copy pointer 2007. When the address designated by the write request received from the AP server 105 is larger than the copy pointer 2007, next, step 6010 is performed. After step 6010, as described above, the write processing execution unit 4100 performs step 6007 and step 6008, and ends the process.

Step 6012: When the address designated by the write request received from the AP server 105 is equal to the copy pointer 2007, it means that the area to be written is being copied. Therefore, the write processing execution unit 4100 turns on the wait flag 2011, and waits until the copy process of the area to be written is completed. After the copying process is completed, the write processing execution unit 4100 again performs step 6011.

Step 6013: When the address designated by the write request received from the AP server 105 is smaller than the copy pointer 2007, the write processing execution unit 4100 determines whether the second SDS ID 2008 is equal to the identifier of the SDS #x(300). If equal, the write processing execution unit 4100 performs step 6001.

Step 6014: When the second SDS ID 2008 is not equal to the identifier of the SDS #x(300), the write processing execution unit 4100 issues a write request to the volume of the SDS 100 identified by the second SDS ID 2008 and the second volume ID 2009 via the network 120. Thereafter, the write processing execution unit 4100 performs step 6007 and step 6008, and ends the process.

In the embodiment, an example in which the write processing execution unit 4100 returns the completion report to the AP server 105 after writing the data to the storage device 220 has been described. However, the write processing execution unit 4100 may return the completion report to the AP server 105 at the time of writing data to the cache area 240, and then may write the data to the storage device 220.

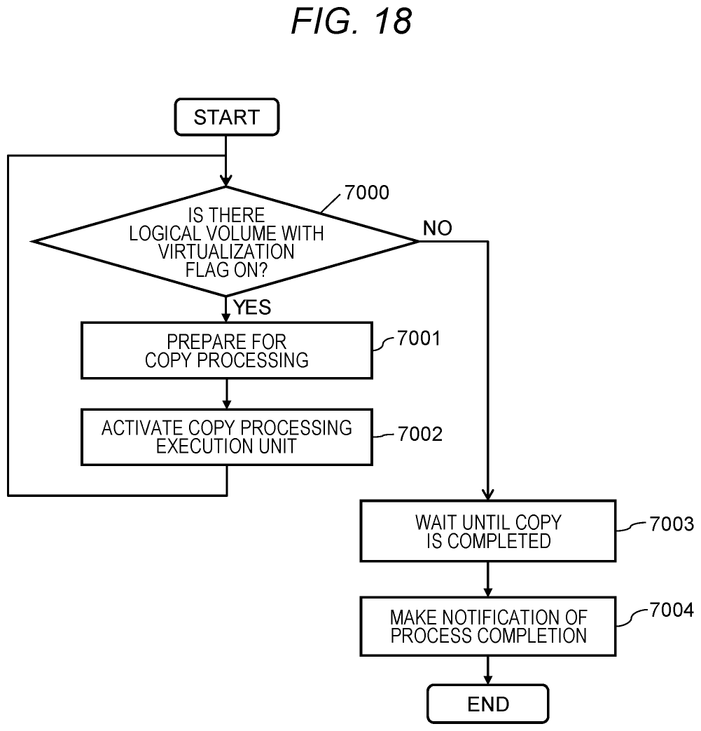

FIG. 18 is a diagram showing a processing flow of the copy processing scheduling unit 4200.

The copy processing scheduling unit 4200 schedules the process of copying the data of the volume of the SDS 100 designated by the management program 150 to another SDS 100. The data copy destination may be the storage device 220 of the SDS #x(300) or may be a volume defined in the SDS 100 other than the designated SDS 100.

Step 7000: The copy processing scheduling unit 4200 finds, in the logical volume information 2000, information whose virtualization flag 2003 is ON and whose SDS ID 2004 is coincident with the designated SDS 100. If not found, since all the logical volumes have been searched for, the process jumps to step 7003 in order to wait for the completion of the copy process.

Step 7001: When a logical volume satisfying the condition is found in step 7000, the copy processing scheduling unit 4200 prepares for the process of copying the found logical volume. Specifically, the copy processing scheduling unit 4200 turns on the in-copying flag 2006 of the found logical volume. Next, the copy processing scheduling unit 4200 determines the copy destination SDS 100 of the data. Any methods may be used for determining the copy destination. For example, the SDS 100 having the largest free area may be selected as the copy destination.

When copying (evacuating) data to SDS 100 other than the SDS #x(300), the copy processing scheduling unit 4200 refers to the logical volume capacity 2002 of the logical volume found in step 7000, and defines a volume of the same size as (or larger than) the logical volume capacity 2002 in another SDS 100. When data is copied to the storage device 220 in the SDS #x(300), the copy processing scheduling unit 4200 determines whether there is a free real page having a capacity larger than the logical volume capacity 2002 of the found logical volume.

When defining a volume in another SDS 100, the copy processing scheduling unit 4200 may exchange information with the SDS 100 that is the definition destination of the volume via the network 120, and may perform the volume definition process. Alternatively, the copy processing scheduling unit 4200 may request the management program 150 to define the volume. The management program 150 may decide the SDS 100 defining the volume, cause the SDS 100 to define the volume of the designated capacity, and return the identifier of the SDS 100 and the identifier of the logical volume to the SDS #x(300).

When the data copy destination is the storage device 220 of the SDS #x(300), the copy processing scheduling unit 4200 sets the identifier of the SDS #x(300) in the second SDS ID 2008. On the other hand, if the copy destination of the data is the volume in another SDS 100, the copy processing scheduling unit 4200 defines the identifier of the SDS 100 having the copy destination volume in the second SDS ID 2008, and set the identifier of the copy destination volume in the second volume ID 2009. Further, the copy processing scheduling unit 4200 sets an initial value (0) to the copy pointer 2007.

Step 7002: The copy processing scheduling unit 4200 activates the copy processing execution unit 4300. At this time, the copy processing scheduling unit 4200 designates the logical volume information 2000 of the logical volume to be copied. After this, the copy processing scheduling unit 4200 performs step 7000 again in order to search for the next logical volume.

Here, the copy processing scheduling unit 4200 does not have to wait until the processing of the copy processing execution unit 4300 is completed. After activating the copy processing execution unit 4300, the copy processing scheduling unit 4200 may immediately return the process to step 7000. Specifically, when the copy processing scheduling unit 4200 activates the copy processing execution unit 4300, the copy processing scheduling unit 4200 generates a process for executing the copy processing execution unit 4300, causes the process to execute the copy processing execution unit 4300, and the copy process scheduling unit 4200 performs step 7000 again.

Also, a plurality of processes to execute the copy processing execution unit 4300 may be generated. When the plurality of processes is generated, they can be performed in parallel. For this reason, for example, a process for performing a copy process on a first logical volume and a process for performing a copy process on a second logical volume may be performed in parallel.

Step 7003: The copy processing scheduling unit 4200 waits until the copy process of all the logical volumes, which is performed in steps 7000 to 7002, is completed.

Step 7004: The copy processing scheduling unit 4200 reports to the management program 150 that the copy process of the specified logical volume of the SDS 100 has been completed, and ends the process. In the above, an example in which the copy process of all volumes of the designated SDS 100 is scheduled has been described. As mentioned above, the copy processing scheduling unit 4200 receives from the user the identifier of the volume requiring copy processing, and may perform only the copy process of the volume requiring the copy processing.

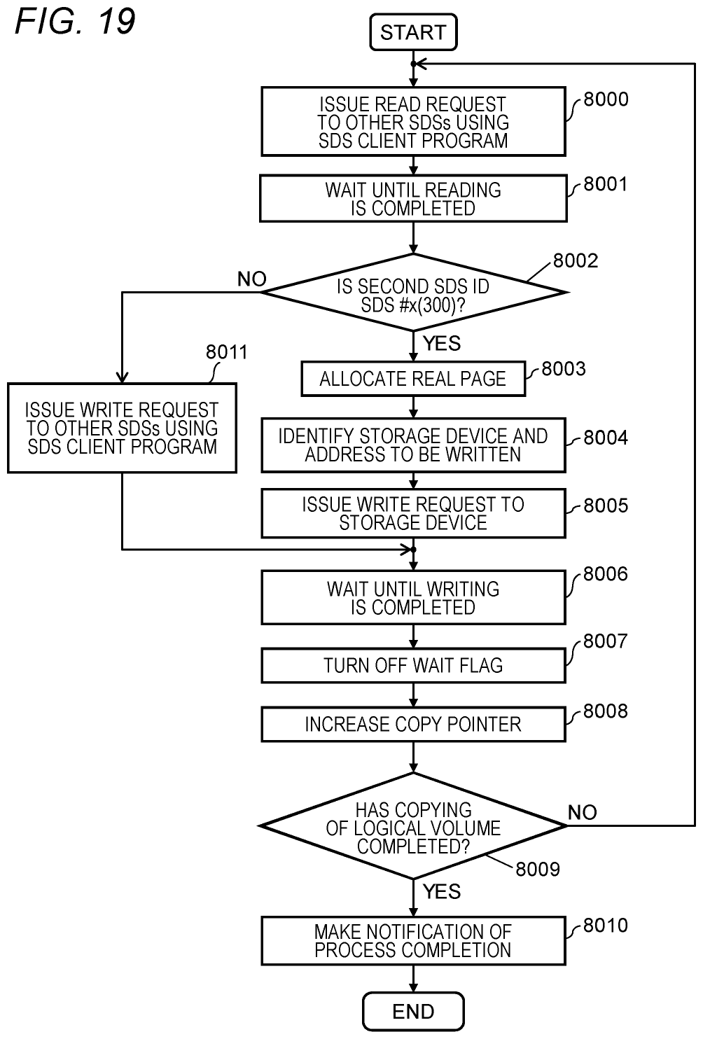

FIG. 19 is a diagram showing a processing flow of the copy processing execution unit 4300.

When called from the copy processing scheduling unit 4200 (step 7002), the copy processing execution unit 4300 starts to perform the process. When the copy processing scheduling unit 4200 calls the copy processing execution unit 4300, it designates the logical volume to be copied. The copy processing execution unit 4300 performs the copy process with respect to the designated logical volume.

Step 8000: The copy processing execution unit 4300 refers to the copy pointer 2007, the SDS ID 2004 and the volume ID 2005 of the designated logical volume to designate a logical volume, a read start address, and a capacity for one virtual page to the corresponding SDS 100, and issue a read request to read data. In this embodiment, when the copy processing execution unit 4300 performs copy processing, an example of copying on a virtual page basis will be described. Copying processing may be performed in unit other than this.

Step 8001: The copy processing execution unit 4300 waits until data is transmitted from the SDS 100 that issued the read request in step 8000.

Step 8002: The copy processing execution unit 4300 determines whether the second SDS ID 2008 is the SDS #x(300). If not, step 8011 is performed. If the second SDS ID 2008 is the SDS #x(300), step 8003 is then performed.

Step 8003: The copy processing execution unit 4300 allocates a real page to the virtual page corresponding to the address identified by the copy pointer 2007. This process is the same process as step 6015.

Step 8004: The process performed here is the same process as the steps 6004 and 6005. The copy processing execution unit 4300 identifies, from the storage device group RAID type 2302 and the storage device pointer 2305, the address of the storage device 220 where the data write destination real page exists. Further, the copy processing execution unit 4300 refers to the storage device group RAID type 2302 to generate necessary redundant data by a known method, and calculates the storage device 220 that stores the redundant data and the address thereof.

Step 8005: The process performed here is the same process as the step 6006. The copy processing execution unit 4300 issues a write request to store data and redundant data to the storage device 220 of the data storage destination and the storage device 220 of the redundant data storage destination identified in step 8004, and migrates the data and the redundant data. Thereafter, the copy processing execution unit 4300 performs step 8006.

Step 8011: If the second SDS ID 2008 is not the SDS #x(300), the copy processing execution unit 4300 refers to the copy pointer 2007, the second SDS ID 2008 and the second volume ID 2009 to designate a logical volume, a read start address, and a capacity for one page to the corresponding SDS 100, issue a write request, and transmit the data to be written. Thereafter, the copy processing execution unit 4300 performs step 8006.

Step 8006: The copy processing execution unit 4300 waits until a response from the storage device 220 (or another SDS 100) is returned.

Step 8007: the copy processing execution unit 4300 refers to the wait flag 2011, releases the process of performing the waiting state if the wait flag 2011 is ON, and turns off the wait flag 2011.

Step 8008: The copy processing execution unit 4300 advances the copy pointer 2007 by one page.

Step 8009: The copy processing execution unit 4300 refers to the copy pointer 2007 and the logical volume capacity 2002, and determines whether the copy pointer 2007 has passed the end address of the logical volume (that is, whether the copying of the relevant logical volume is completed). If the copying of the logical volume is not completed, the copy processing execution unit 4300 repeats the process from step 8000 again.

Step 8010: When the copying of the logical volume is completed, the copy processing execution unit 4300 turns off the in-copying flag 2006. Further, if the second SDS ID 2008 is an identifier of the SDS #x(300), the copy processing execution unit 4300 turns off the virtualization flag 2003. When the second SDS ID 2008 is not an identifier of the SDS #x(300), the copy processing execution unit 4300 copies the second SDS ID 2008 and the second volume ID 2009 to the SDS ID 2004 and the volume ID 2005, and ends the process.

The copy processing execution unit 4300 moves (copies) the data of one logical volume to another storage area by performing the above-described process. Even during the copying process by the copy processing execution unit 4300, the read processing execution unit 4000 or the write processing execution unit 4100 can perform the data read process or the data write process of the logical volume. Since the read processing execution unit 4000 is configured to perform the process (steps 5008 to 5013) specifically described in FIG. 15, data can be read without waiting for the completion of the copy process of the copy processing execution unit 4300 even if the logical volume to be read is being copied by the copy processing execution unit 4300. Similarly, the write processing execution unit 4100 can write data without waiting for the completion of the copy process of the copy processing execution unit 4300 by performing the process shown in FIG. 17. For this reason, the user can perform program exchange of the SDS #y(301) without stopping the operation (for example, without stopping an access to the logical volume from the AP server 105).

Although the embodiment of the present invention has been described above, this is an example for explaining the present invention, and the scope of the present invention is not limited to these embodiments. That is, the present invention can be implemented in various other forms.

In the embodiment described above, the SDS #x(300) executes the management program 150, and manages each storage apparatus (SDS) in the information system. The management program 150 may not necessarily be executed by the SDS #x(300). For example, as the management server 140 executes the management program 150, the management server 140 may be configured to manage each SDS 100 in the information system. Alternatively, the management program 150 may be executed by the AP server 105.

In addition, in the embodiment described above, although there was a server computer for each application (SDS 100, AP server 105, management server 140), one server computer may be configured to serve plural applications. For example, the client program executed by the management server 140 in the above-described embodiment may be configured to be executed by the SDS 100. In this case, the user performs a management operation using the input/output device (keyboard and display) provided in the SDS 100.

Alternatively, the information system may be configured such that the application program and the storage control program 130 are executed by the same server computer. In this case, this server computer performs the functions of both the AP server and the SDS in the embodiment described above.

Also in this case, a plurality of virtual computers may be defined on the server computer, and the application program and the storage control program may be executed on the virtual computer. For example, a virtual computer that executes an application program, and a virtual computer that executes a storage control program are defined by running the hypervisor on the server computer. The virtual computer executing the storage control program may be configured to provide the volume to the virtual computer (or a server computer or the like other than this computer) that executes the application program. However, each program may not necessarily be executed on the virtual computer. For example, the program code for performing processing equivalent to the storage control program described above is included in the hypervisor, and the server computer executes this hypervisor, so that the configuration may be constructed to provide a volume to the virtual computer that executes the application program.

Also, part of the above-described processing may be performed manually. For example, in the processing described with reference to FIG. 17, the management program 150 instructs the copy processing scheduling unit 4200 to perform step 10030, and thereafter, instructs the program exchange to the SDS 100 (SDS #y(301)) whose program is to be changed. Part of this process may be performed by the user. That is, after the user can validate the end of step 10030 (data migration of the SDS #y(301)), the user may perform the exchange of the program of the SDS #y(301).

In exchange of the program at this time, the user instructs from the management server 140 the management program 150 of the SDS #x(300) to install the program to the SDS #y(301), thereby causing, from the management program 150, the install program 250 of the SDS #y(301) to perform the program exchange, or may instruct installation of the program to the install program 250 of the SDS #y(301) directly from the management server 140. Alternatively, when the SDS #y(301) has an input/output device such as a keyboard or a display, the user may use it to instruct SDS #y(301) to install the program.

Further, in the above-described embodiment, an example in which the I/O request (command) accepted by the SDS is a so-called SCSI command has been described. That is, the example in which the SDS is a storage apparatus that accepts a so-called block level access request has been described. However, the SDS may be another type of storage apparatus. For example, it may be a storage apparatus (so-called Network Attached Storage (NAS) or Object-based Storage Device (OSD)) that accepts access requests of file level or object level.

Further, in the above-described embodiment, an example in which when the data of the logical volume is migrated to a storage area other than the SDS #y(301) by the copy processing execution unit 4300, the storage area of the migration destination is either a storage device of the SDS #x(300) or a volume of another SDS 100 has been described. However, both of the storage device of the SDS #x(300) and the volume of another SDS 100 may be used as the storage area of the migration destination.

For example, in the SDS #x(300), the SDS #y(301-1) and the SDS #y(301-2) shown in FIG. 3, when program exchange of the SDS #y(301-1) is performed, the data stored in LV2 needs to be migrated to SDS other than SDS #y(301-1) (Note that LV2 is mapped to LVI by the virtualization function). In this case, the SDS #x(300) may migrate part of the data stored in the LV2, for example, half the data from the head of LV2, to the storage device 220 of the SDS #x(300), and may migrate the remaining data to the volume LV3 of, for example, SDS #y(301-2). Naturally, in this case, the SDS #x(300) needs to be configured so as to be able to allocate a storage area of a different volume (or a storage area of the storage device 220) for each area of the logical volume (for example, for each virtual page).

Further, for example, instead of providing the management program 150, the function of the management program 150 may be included in the storage control program 130.

In addition, each program that causes the CPU to execute the above-described processing may be provided in a state where it is stored in a storage medium readable by the computer, and may be installed in each device that executes the program. The storage medium readable by the computer is a non-transitory computer readable medium, for example, a nonvolatile storage medium such as an IC card, an SD card, or a DVD. Alternatively, each program that causes the CPU to execute the above-described processing may be provided by the program distribution server via the network.

Further, in the above-described embodiment, one SDS is a single computer (for example, a server computer). One SDS may be a plurality of computers each of which executes the identical storage control program 130. A single computer may be part of each of a plurality of SDS systems. Also, the “SDS” may mean to cover the entire software-defined device (for example, SDDC (Software-defined Datacenter)) having the function of storing data. In addition to the SDS, the computer may execute one or more virtual computers as a host system that issues an I/O request to the SDS. In addition to the storage function, the SDS may have a host function (a function as a host system that issues an I/O request to the storage function).

Further, “storage device group” may be an example of a redundant configuration group. Examples of the redundant configuration include an Erasure Coding, a RAIN (Redundant Array of Independent Nodes), an inter-node mirroring, a RAID. Any redundant configuration may be used. Accordingly, the “storage device” may be a storage medium such as an NVRAM (Non-Volatile RAM) or a node (for example, a general-purpose computer) as a component of a scale-out storage system.

The above explanation can be summarized as follows. The following explanation may include items not mentioned above.

In an information system (for example, SDS #x(300)) including a plurality of computers each of which includes a processor and a storage device, where the information system inputs/outputs data to/from the storage device based on a request from a client program, when migrating data stored in a migration source information system (for example, SDS #y(301)) to a storage device of a self information system (for example, SDS #x(300)), the processor transmits an instruction to cause a client program (for example, SDS client program 260y) exerted on the migration source information system as the data migration source to generate an access means to access the data to be migrated of the migration source information system, and stores the data to be migrated in the storage device of the information system using the access means generated by the client program of the migration source information system.

The client program exerted on the migration source information system may be a program (for example, SDS client program 260y-1) installed in each computer of the information system.

A protocol that the migration source information system uses to communicate with the client program may be different from a protocol that the self information system uses for communication, and a protocol in which the self information system and the migration source client program communicate with each other may be a standardized protocol.

The generation of the access means is a volume (for example, volume LV0) generated outside the migration source information system in order to access the data in the migration source information system.

Such an information system may be constructed by executing a program group which is one or more programs installed and executed on and by a computer. The program group may be a program (for example, a program for inputting and outputting to and from a storage device) that exercises a storage function like the storage control program 130 described above, and in addition to the program, may include a program for controlling the installation of the client program and the like as in the above-described management program 150.

What is claimed is:

1. All information system comprising a plurality of computers each of which includes a processor and a storage device, the information system inputting/outputting data to/from the storage device based on a request from a client program,
wherein when migrating data stored in a migration source information system to a storage device of a self information system,
the processor
transmits an instruction to cause a client program exerted on the migration source information system as the data migration source to generate an access means to access the data to be migrated of the migration source information system, and
stores the data to be migrated in the storage device of the information system using the access means generated by the client program of the migration source information system.

2. The information system according to claim 1,
wherein the client program exerted on the migration source information system is a program installed in each computer of the information system.

3. The information system according to claim 1,
wherein a protocol that the migration source information system uses to communicate with the client program is different from a protocol that the self information system uses for communication, and
wherein a protocol in which the self information System and the migration source client program communicate each other is a standardized protocol.

4. The information system according to claim 1,
wherein generating the access means includes a volume generated outside the migration source information system in order to access the data in the migration source information system.

5. An information processing method for inputting/outputting data to/from the storage device based on a request from a client program,
wherein when migrating data stored in a migration source information system to a storage device of a information system,
the method comprising:
transmitting an instruction to cause a client program exerted on the migration source information system as the data migration source to generate an access means to access the data to be migrated of the migration source information system, and
storing the data to be migrated in the storage device of the information system using the access means generated by the client program of the migration source information system.

6. A non-transitory computer readable recording medium storing a computer program that inputs/outputs data to/from the storage device of an information system based on a request from a client program, the computer program causing a computer to
when migrating data stored in a migration source information system to a storage device of an information system,
transmit an instruction to cause a client program. exerted on the migration source information system as the data migration source to generate an access means to access the data to be migrated of the migration source information system, and
store the data to be migrated in the storage device of the information system using the access means generated by the client program of the migration source information system.
